(19) United States
(12) Patent Application Publication
(10) Pub. No.: US 2023/0058710 A1
(43) Pub. Date: Feb. 23, 2023

(54) SCALED CONTENT LICENSING PLATFORM AND MARKETPLACE SYSTEMS, METHODS, AND MEDIA

(71) Applicant: Google LLC, Mountain View, CA (US)

(72) Inventors: Kevin G. Montler, Pleasanton, CA (US); David E. Rosenstein, San Francisco, CA (US); Lucas Pollock, San Francisco, CA (US); Michael William Springer, Zurich (CH)

(21) Appl. No.: 17/886,959

(22) Filed: Aug. 12, 2022

Related U.S. Application Data
(60) Provisional application No. 63/233,735, filed on Aug. 16, 2021.

(51) Int. Cl. G06Q 30/06

(52) U.S. Cl. CPC G06Q 30/0601; G06Q 2220/18

(57) ABSTRACT

Scaled content licensing platform and marketplace systems, methods, and media are provided. In some embodiments, a method for providing scaled content licensing is provided, where the method includes: receiving a request from a content creator to upload a media content item to a content sharing service; determining that the media content item incorporates a media asset that is owned at least partially by a partner, wherein the media asset is associated with a claim in which at least one license is available; determining whether a license usage is associated with the media content item that corresponds with the media asset; generating a claim bundle that contains the claim associated with the partner and the license usage associated with the content creator; determining a policy based on the generated claim bundle; and performing an action on the media content item based on the determined policy.

### CROSS-REFERENCE TO RELATED APPLICATION

This application claims the benefit of U.S. Provisional Patent Application No. 63/233,735, filed Aug. 16, 2021, which is hereby incorporated by reference herein in its entirety.

### TECHNICAL FIELD

The disclosed subject matter relates to scaled content licensing platform and marketplace systems, methods, and media.

### BACKGROUND

Currently, if a content creator of a video uploads a video that includes popular music within the video, the content creator receives a third party claim from a music owner that triumphs over their own first party claim. As such, the content creator cannot make money from the video as the revenue is directed to the partners who own the music. This is an increasingly large problem as content creators as owners of intellectual property assets (e.g., a video, a book, a song, a video game, etc.) have a growing desire to monetize their assets.

Accordingly, it is desirable to provide new scaled content licensing platform and marketplace systems, methods, and media.

### SUMMARY

In accordance with various embodiments, scaled content licensing platform and marketplace mechanisms (which can include methods, systems, and media) are provided.

In accordance with some embodiments of the disclosed subject matter, a method for providing scaled content licensing is provided, the method comprising: receiving, using a hardware processor, a request from a content creator to upload a media content item to a content sharing service; determining, using the hardware processor, that the media content item incorporates a media asset that is owned at least partially by a partner, wherein the media asset is associated with a claim in which at least one license is available; determining, using the hardware processor, whether a license usage is associated with the media content item that corresponds with the media asset; generating, using the hardware processor, a claim bundle that contains the claim associated with the partner and the license usage associated with the content creator; determining, using the hardware processor, a policy based on the generated claim bundle; and performing, using the hardware processor, an action on the media content item based on the determined policy.

In some embodiments, the license usage is stored in a child table of a claim table that stores a plurality of claims that are each associated with one or more licenses. In some embodiments, the license usage is stored as a field of a claim table that stores a plurality of claims that are each associated with one or more licenses. In some embodiments, the license usage is stored as a claim type of a claim table that stores a plurality of claims that are each associated with one or more licenses. In some embodiments, the license usage is stored in a license usage database that is separate from a claim database that stores a plurality of claims that are each associated with one or more licenses.

In some embodiments, the method further comprises detecting whether the media content item includes one or more media assets in response to receiving the request to upload the media content item to the content sharing service, wherein the claim is generated in response to detecting the media asset in the media content item in which the media asset is owned at least partially by the partner.

In some embodiments, the method further comprises determining that the at least one license can be acquired from the partner, wherein the at least one license is associated with license terms.

In some embodiments, the method further comprises causing license options to be presented to the content creator in response to determining that the at least one license can be acquired from the partner. In some embodiments, the license terms include an option to purchase the at least one license based on revenue generated from the media content item. In some embodiments, the license terms include an option to purchase the at least one license using an electronic payment system associated with a user account of the content creator.

In some embodiments, the action performed on the media content item based on the determined policy includes determining whether to inhibit the media content item from being provided to other users of the content sharing service based on the determined policy. In some embodiments, the action performed on the media content item based on the determined policy includes determining whether the media content item is eligible for monetization based on the determined policy.

In some embodiments, the method further comprises generating one or more recommendations for replacing the media asset included in the media content item in response to determining that the at least one license is unavailable for acquisition from the partner corresponding to the media asset.

In some embodiments, the method further comprises: receiving a selection of a purchased license that is associated with the media asset; and activating the purchased license in which the purchase license is applied to the media content item.

In some embodiments, the method further comprises determining a license strategy is associated with the media asset. In some embodiments, the license strategy indicates a gratis license associated with the media asset. In some embodiments, the gratis license is associated with a usage expiration term, a territorial usage term, a time usage term, and a license usage term and wherein the gratis license is specified by the partner to one or more content creators using a user identifier.

In some embodiments, the method further comprises transmitting the media asset to the content creator for temporary insertion into the media content item.

In accordance with some embodiments of the disclosed subject matter, a scaled content licensing system is provided, the system comprising a server that includes a hardware processor, wherein the hardware processor is configured to: receive a request from a content creator to upload a media content item to a content sharing service; determine that the media content item incorporates a media asset that is owned at least partially by a partner, wherein the media asset is associated with a claim in which at least one license is available; determine whether a license usage is associated with the media content item that corresponds with the media asset; generate a claim bundle that contains the claim associated with the partner and the license usage associated with the content creator; determine a policy based on the generated claim bundle; and perform an action on the media content item based on the determined policy.

In accordance with some embodiments of the disclosed subject matter, a non-transitory computer-readable medium containing computer-executable instructions that, when executed by a processor, cause the processor to perform a method for providing scaled content licensing is provided, the method comprising: receiving a request from a content creator to upload a media content item to a content sharing service; determining that the media content item incorporates a media asset that is owned at least partially by a partner, wherein the media asset is associated with a claim in which at least one license is available; determining whether a license usage is associated with the media content item that corresponds with the media asset; generating a claim bundle that contains the claim associated with the partner and the license usage associated with the content creator; determining a policy based on the generated claim bundle; and performing an action on the media content item based on the determined policy.

In accordance with some embodiments of the disclosed subject matter, a system for providing scaled content licensing is provided, the system comprising: means for receiving a request from a content creator to upload a media content item to a content sharing service; means for determining that the media content item incorporates a media asset that is owned at least partially by a partner, wherein the media asset is associated with a claim in which at least one license is available; means for determining whether a license usage is associated with the media content item that corresponds with the media asset; means for generating a claim bundle that contains the claim associated with the partner and the license usage associated with the content creator; means for determining a policy based on the generated claim bundle; and means for performing an action on the media content item based on the determined policy.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1-4 show an illustrative example of a scaled content licensing platform and marketplace system in accordance with some embodiments of the disclosed subject matter.

FIG. 5 shows an illustrative license flow diagram between a content sharing service, partners of the content sharing service that have assets for licensing, creators of the content sharing service that upload content items that may include one or more assets, and viewers of content provided by the content sharing service in accordance with some embodiments of the disclosed subject matter.

FIG. 6 shows an illustrative example of used content or assets within a content item in accordance with some embodiments of the disclosed subject matter.

FIGS. 7-10 and 12-18 show illustrative examples of data categories that describe creator content, used content, and licenses in accordance with some embodiments of the disclosed subject matter.

FIG. 11 shows an illustrative flow diagram of license states through asset, license proposal, license provision, license acquisition, and license usage in accordance with some embodiments of the disclosed subject matter.

FIG. 19 shows an illustrative example of two instances of content reuse in a content item, where each instance of content reuse has a license, in accordance with some embodiments of the disclosed subject matter.

FIG. 20 shows an illustrative example of a match license and a direct license that can be associated with an asset in accordance with some embodiments of the disclosed subject matter.

FIG. 21 shows an illustrative example of a license table that stores licenses and license terms in accordance with some embodiments of the disclosed subject matter.

FIGS. 22-24 show illustrative examples of the relations between rights management mechanisms, commerce mechanisms, and content management mechanisms in storing information relating to items for licensing, items for download or preview, license strategies, and one or more offers associated with each item in accordance with some embodiments of the disclosed subject matter.

FIGS. 25-44 show illustrative examples of storefront user interfaces that allow a creator to upload a content item, perform checks for any issues that may restrict the visibility or monetization of the content item, acquire a license to detected assets within the content item (if available), and apply an acquired license to the content item in accordance with some embodiments of the disclosed subject matter.

FIGS. 45-50 show illustrative examples of storefront user interfaces that allow a partner to create and/or assign license strategies to one or more assets in accordance with some embodiments of the disclosed subject matter.

FIG. 51 shows an illustrative architecture that uses the storefront to transmit a search query or filter selections and, in response, receive assets with metadata, usage terms, and available licenses in accordance with some embodiments of the disclosed subject matter.

FIG. 52 shows an illustrative flow diagram showing how the storefront user interface is used to transmit a search query or filter selections and, in response, receives assets with metadata, usage terms, and available licenses in accordance with some embodiments of the disclosed subject matter.

FIG. 53 shows an illustrative example of the relationship between content items, licenses, license acquisitions, license usages, assets, and claims in accordance with some embodiments of the disclosed subject matter.

FIGS. 54-57 show illustrative examples of how license usage information can be stored in connection with claim information and how a logic layer can compute the effective policy based on such license usage and claim information in accordance with some embodiments of the disclosed subject matter.

FIGS. 58-60 show illustrative examples of the interactions between partner asserted claims, licensed usage marketplace claims, overall video policy, and an ownership snapshot in accordance with some embodiments of the disclosed subject matter.

FIGS. 61-68 show illustrative examples of the interactions between the match claiming mechanisms, the rights management mechanisms, and the licensing application engine in accordance with some embodiments of the disclosed subject matter.

FIG. 69 shows a schematic diagram of an illustrative scalable content licensing system suitable for implementation of the mechanisms described herein in accordance with some embodiments of the disclosed subject matter.

FIG. 70 shows a detailed example of hardware that can be used in a content server, a data server, and/or a user device of FIG. 69 in accordance with some embodiments of the disclosed subject matter.

### DETAILED DESCRIPTION

In accordance with various embodiments, scaled content licensing platform and marketplace mechanisms (which can include methods, systems, and media) are provided.

In accordance with some embodiments, the mechanisms described herein can allow content creators (sometimes referred to herein as “creators”) to acquire licenses to content assets directly from partners, such as music partners or entertainment partners, and then apply the acquired licenses in their content items. This can, for example, allow a content creator to monetize a content item and participate in revenue sharing when third party content from a partner is detected and claimed in a content item uploaded by the content creator. In addition, a viewer of the content item uploaded by the content creator to a content sharing service can include the associated license information during playback of the content item.

It should be noted that, although the embodiments described herein generally relate to providing mechanisms for allowing a content creator to acquire a license for a song or other music content directly from a partner, such as a music partner, and applying the acquired license to the song to a content item (e.g., a video) being uploaded to a content sharing service, this is merely illustrative. The mechanisms described herein can allow content creators to directly acquire licenses for any suitable type of content, such as video content, image content, audio content, art content, a unique cryptographic digital asset (e.g., a nonfungible token container file), etc.

As used herein, a direct license can be acquired by a creator, where the license grants the creator certain rights to use the underlying assets in their content items.

Each content item that has been uploaded to a content sharing service can be associated with a licensed status. For example, an unlicensed status can be assigned to a content item that has been uploaded to the content sharing service that contains an asset or other intellectual property asset which is not explicitly licensed by the content sharing service or by the content creator that uploaded the content item. Such content (e.g., a Hollywood movie that has been uploaded to the content sharing service) is blocked or otherwise inhibited from being provided to other users of the content sharing service. In another example, an allowed status can be assigned to a content item that has been uploaded to the content sharing service that contains an asset or other intellectual property which is not explicitly licensed by the content creator that uploaded the content item, but has been licensed by the content sharing service. Such content (e.g., user-generated content that has been uploaded to the content sharing service) can be provided to other users of the content sharing service for as long as the license with the content sharing service is active. In yet another example, a licensed status can be assigned to a content item that has been uploaded to the content sharing service that contains an asset or other intellectual property asset which has been explicitly licensed for usage on the content sharing service by the content creator that uploaded the content item. This can, in some implementations, also include content that falls under exceptions to copyright laws like the fair use exception and public domain.

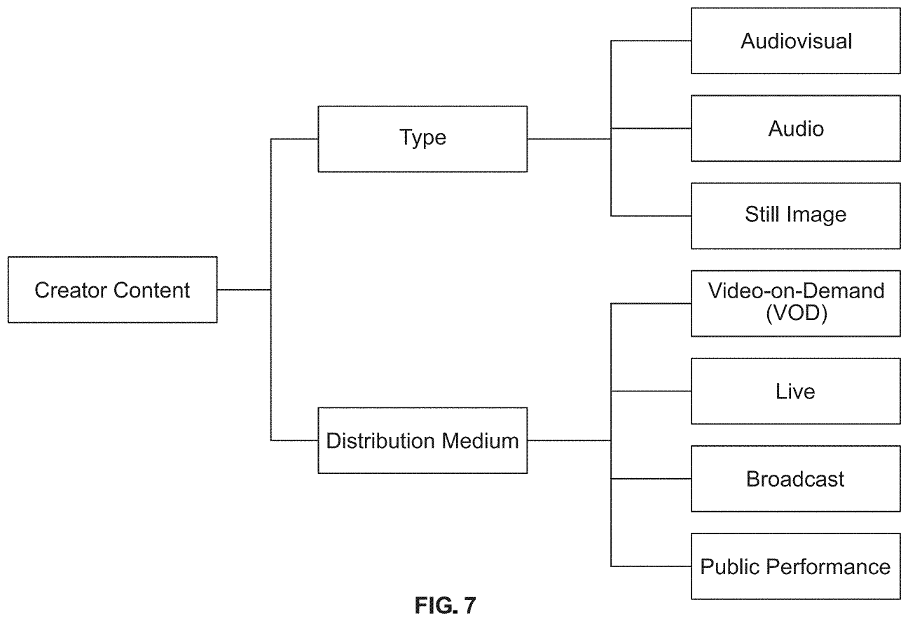

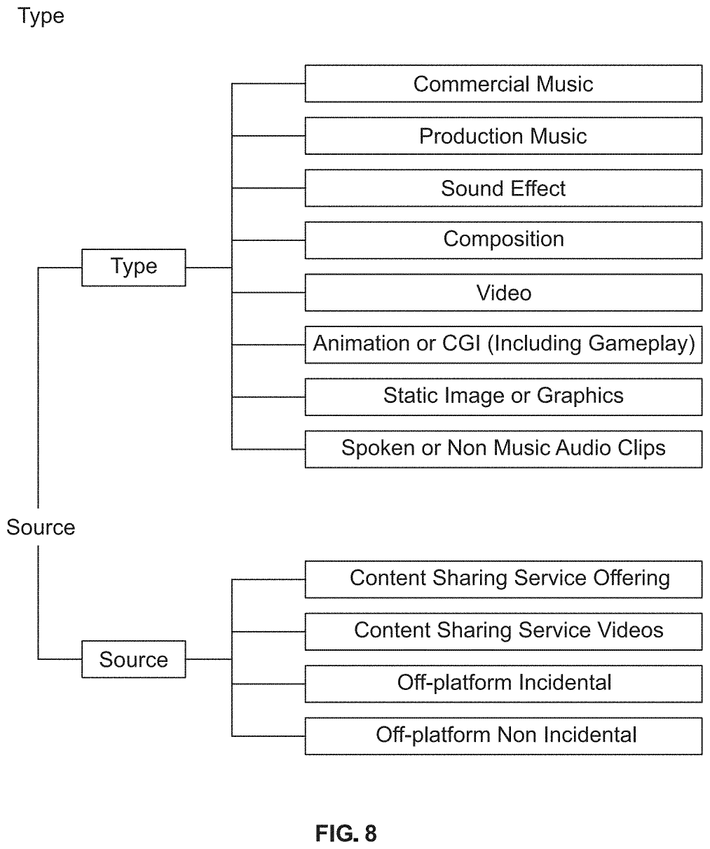

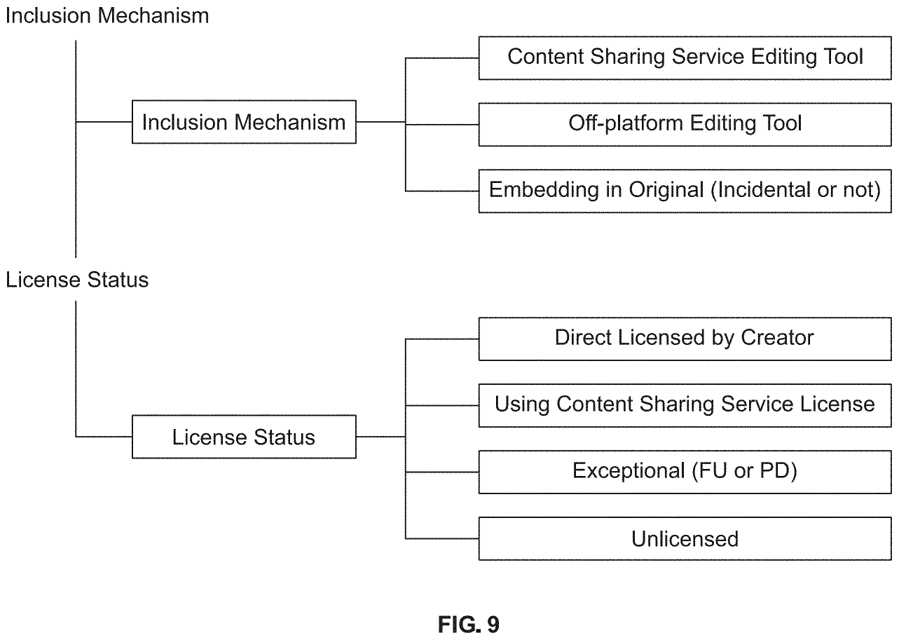

As used herein, an asset can generally refer to any content, such as creator content or content that has been uploaded to the content sharing service (which may contain existing intellectual property or intellectual property that the creator created) or used content or content that has been uploaded to the content sharing service that is found in creator content. As shown in FIG. 7, creator content can include any suitable audiovisual content, audio content, image content, and/or any other suitable type of content and can be associated with any suitable distribution medium, such as video-on-demand (VOD), live content, broadcast content, and public performance content. As shown in FIG. 8, used content can include any suitable audio content, audiovisual content, melodic content, etc. As also shown in FIG. 8, used content can be associated with any suitable source, such as a video uploaded to the content sharing service. As shown in FIG. 9, used content can also be associated with an inclusion mechanism and a license status described above (e.g., direct license, licensed by the content sharing service, a copyright exception, or unlicensed).

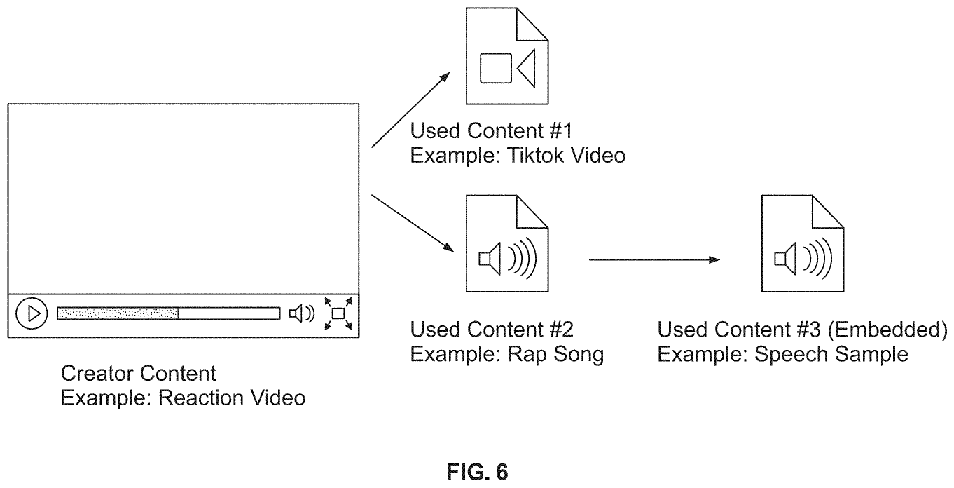

As used herein, an embed can generally refer to the presence, whether detected, inferred, or declared, of any used content in another piece of used content. This is shown, for example, in FIG. 6, where used content #3 (e.g., speech content) is embedded in used content #2 (e.g., music content).

As mentioned hereinabove, a license can be acquired by a creator, where the license grants the creator certain rights to use the underlying assets in their content items. Such a license can include license terms and ancillary data.

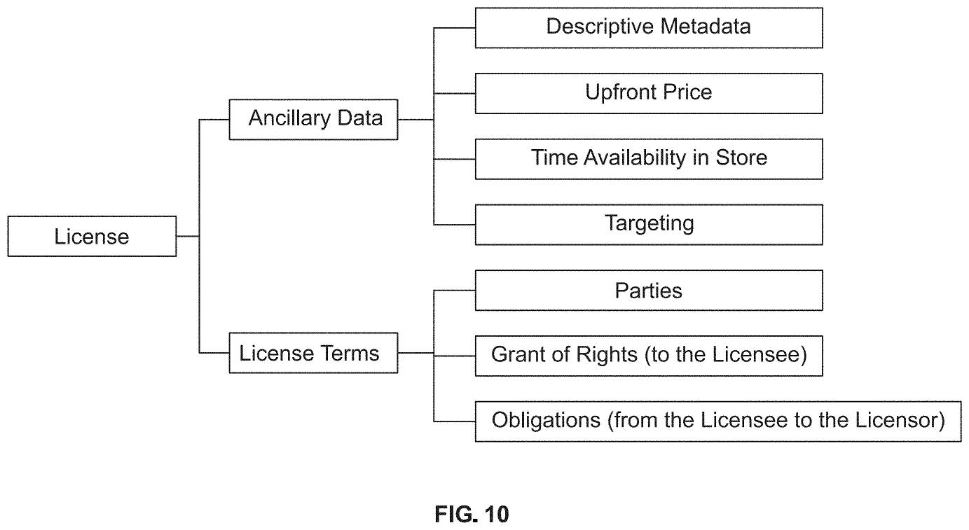

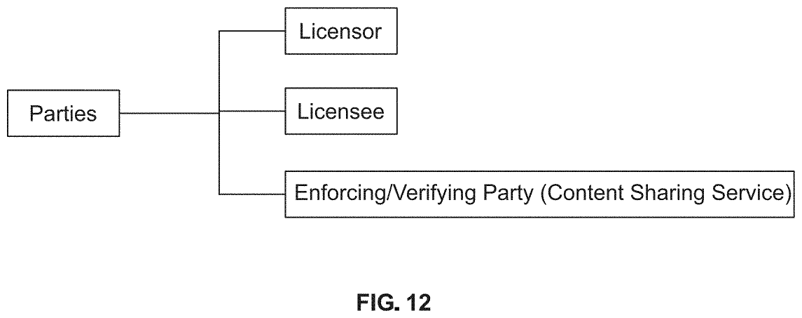

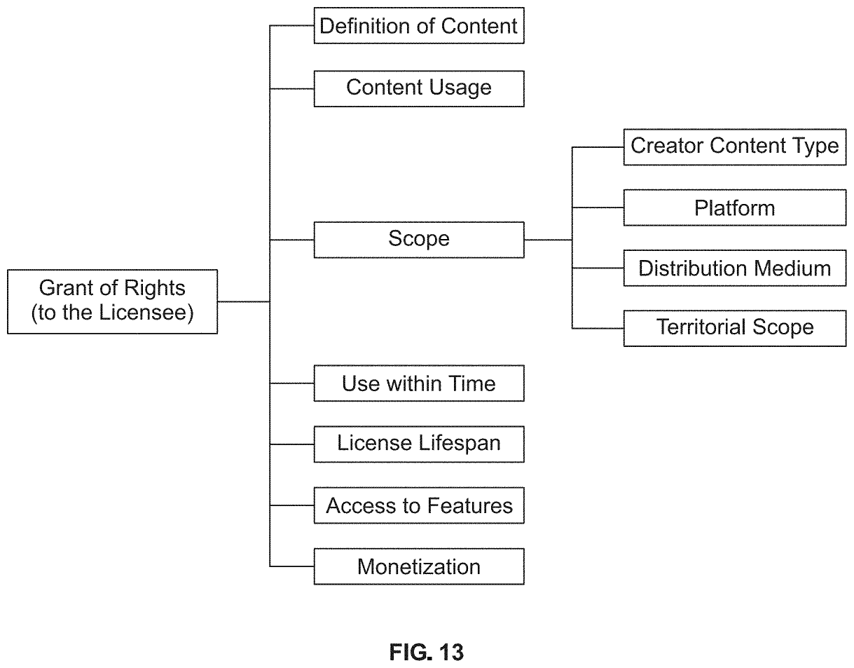

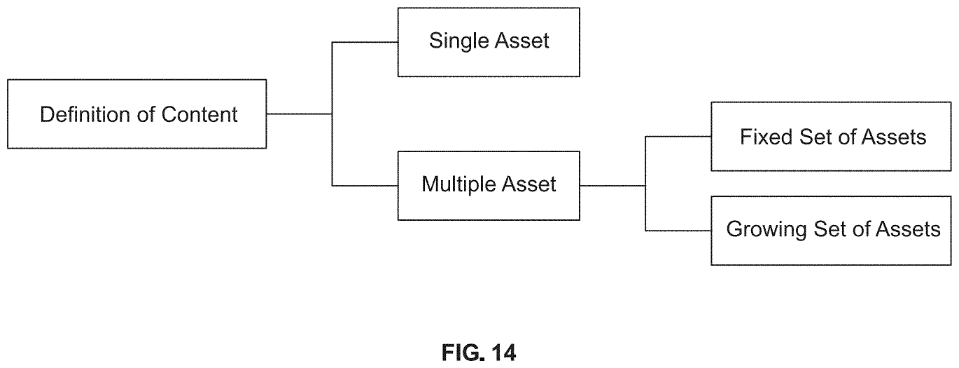

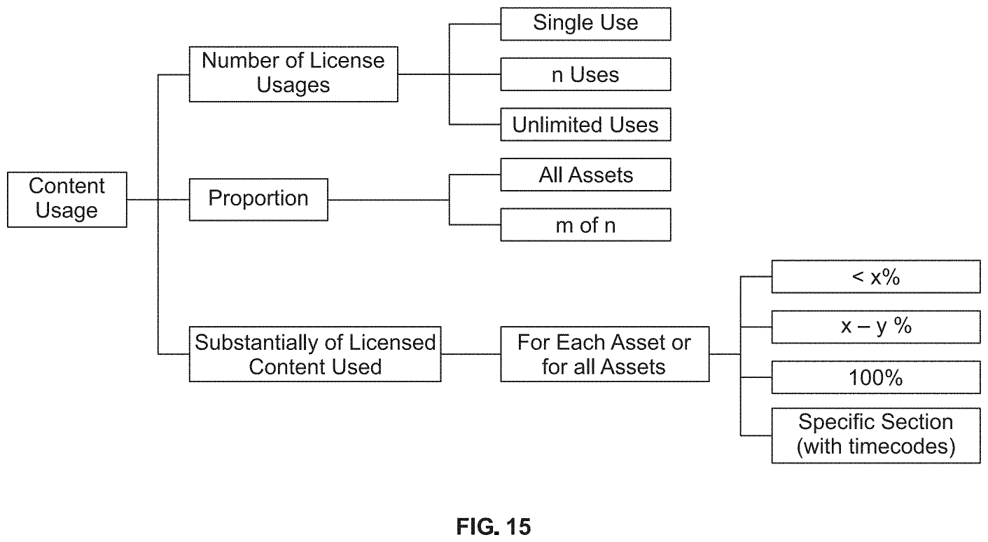

As shown in FIG. 10, terms can be used to define who the contract is for (parties), what is covered (asset), what the licensor expects (obligations from the licensee to the licensor), what the licensee can do with the licensed asset (grant of rights to the licensee), etc. FIG. 12 further illustrates that the parties in the license term can include a licensor, a licensee, and an enforcing or verifying party. For example, a licensor can be a partner or content owner, a licensee can be a creator that is represented by a channel identifier associated with the content sharing service, and an enforcing or verifying party can be an identifier associated with the content sharing service. FIG. 13 further illustrates that a grant of rights to the license can include a definition of the content, content usage, scope, use within a particular time, license lifespan, access to features, monetization information, etc. FIG. 14 further illustrates that a definition of the content or asset covered by the license can be defined by a set of asset identifiers. For example, the license can cover a single asset. In another example, if the license covers an album, the asset identifiers can be encoded in the license terms under “definition of content” and then “multiple assets.” It should be noted that, in some embodiments, in addition to a fixed set of assets, a license can be granted to a growing set of assets (such as a grant to a catalog of assets for a given partner). FIG. 15 further illustrates content usage within a license. For example, content usage can define how many times a license can be used (e.g., single use, n number of uses, or unlimited uses). For licenses covering multiple assets, a given license usage can be provided for a subset of assets (e.g., m assets out of the n available assets) or can provide that all assets can be used. For each asset covered by the license, content usage can define how much of it can be used, where some licenses can make only certain parts of the asset's reference available.

Ancillary data can be used to describe the license (descriptive metadata) and can contain display and pricing or targeting information for usage in the marketplace, such as upfront price, time availability in the marketplace, etc. For example, key terms from the license can be displayed in the marketplace. Once acquired, the mechanisms can set particular terms, such as a channel identifier that identifies who the license is for. Generally speaking, terms can be fixed once the license for an asset is made available. An exception to this may be when the licensor wants to expand the assets covered by the license. In some embodiments, terms can be defined in a section describing the parties of the contract, a section describing the rights granted by the contract, and a section describing the obligations the licensee has towards the licensor.

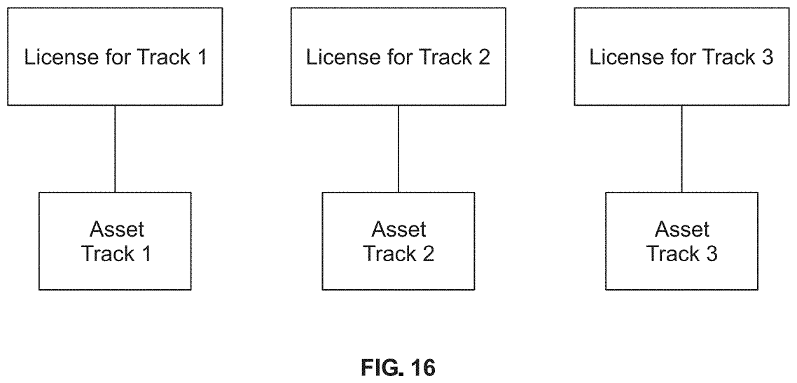

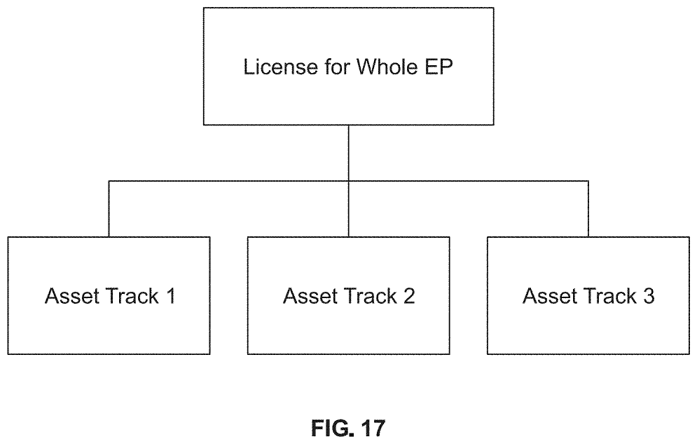

It should be noted that, in some embodiments, each asset can have its own license. This is shown, for example, in FIG. 16. Additionally or alternatively, in some embodiments, one license can be generated that covers all of the assets. This is shown, for example, in FIG. 17. This can, for example, allow a partner or licensor to bundle their content at a preferential price, throw in freebies, and control their licenses for broad categories of content. By defining the content usage section of the terms to 1 of n available assets can allow a partner or licensor to offer a catalog for choice under one license, but only one asset may be used each time for each license usage.

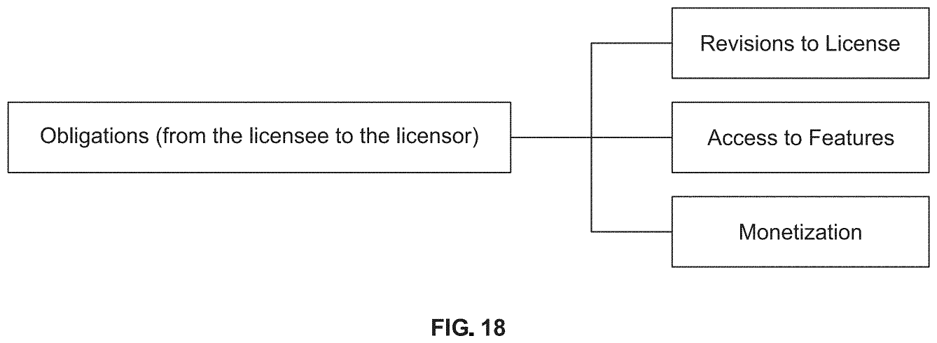

Referring back to the license terms included in a license in FIG. 10, FIG. 18 further illustrates that the obligations section of the license terms can include revisions to the license, access to features, and monetization where the licensee of the asset can monetize the content item that the asset is included.

It should be noted that can be three levels of time controls for licenses:

| | License | | |
|---|---|---|---|
| Control name | object | Description | Where is it stored? |
| Time | License | After this date/time, | Ancillary data |
| availability | | the license is not | |
| in store | | available in the | |
| | | storefront any longer | |
| Use within | Acquired | After this date/time | Terms > Grant of |
| time | License | since acquisition, the | rights |
| | | license cannot be | |
| | | used anymore | |
| License | License | After this date/time | Terms > Grant of |
| lifespan | Usage | since using it on a | rights |
| (or valid | | UGC, the license is | |
| within time) | | not valid anymore | |
| | | and reverts to default | |
| | | UGC/n-way. | |

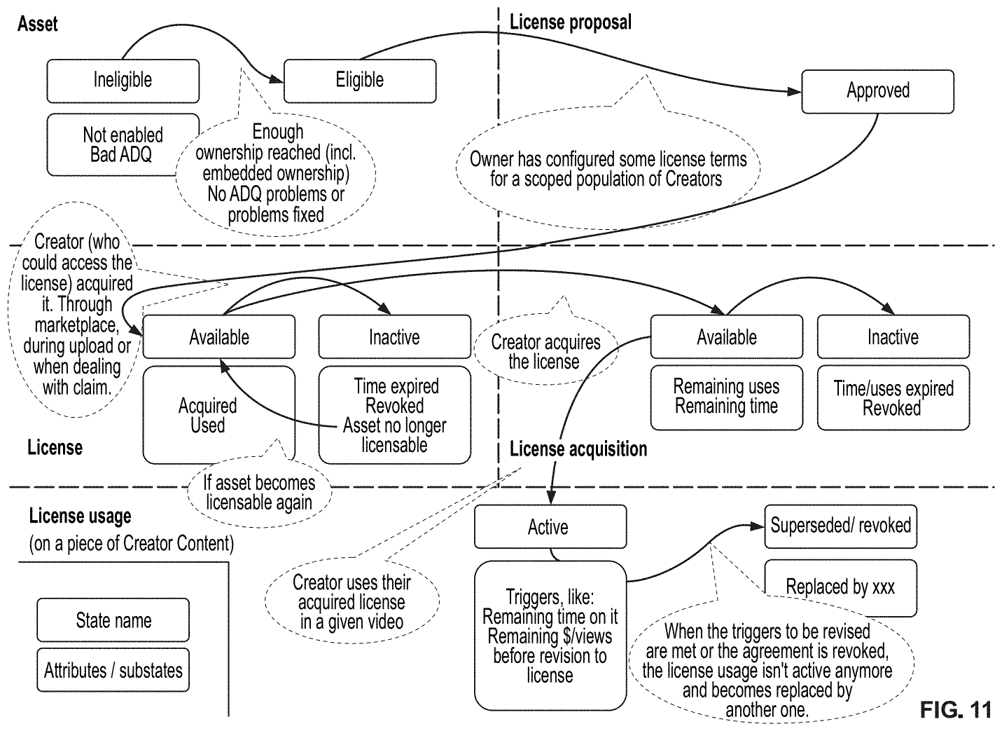

It should also be noted that there are various license objects. For example, a license strategy can be a collection of license templates, where a license template can be a preset for license parameters that can be reused when new licenses are to be created. A license can be defined as an object shown in the storefront and can be acquired by eligible creators. This license in the marketplace can move between an available state and an inactive state. A license acquisition can be defined as a state that the license turns into after being acquired by a creator, which can then be available for use on that creator's content item (e.g., video). The license acquisition can, for example, move between (i) an available state in which a remaining number of uses and/or a remaining time allows the creator to apply the license and (ii) an inactive state in which no time or uses remain for the creator to apply the license to a content item or in which the license has been revoked. A license usage can be defined as a state that the license acquisition turns into after being applied to a content item and stored on a claim. The license usage can move between an active state and a revoked or superseded state such that, when the triggers for a license to be revised are met or the license is revoked, the license usage transitions from an active state to a revoked state and may be replaced by another license. For example, when a trigger is met (e.g., remaining time on the license, remaining dollar amount or views before revision to the license, etc.), the license usage term can move to a superseded state and can point to a new license usage created to replace it. As such, the former license usage's terms are not being applied on this piece of content. An illustrative example of the state transitions between an asset, a license proposal, a license, and a license usage is shown in FIG. 11.

Referring back to the license terms included in a license in FIG. 10, FIG. 12 shows that the parties in the license term can include a licensor, a licensee, and an enforcing or verifying party. For example, a licensor can be a partner or content owner, a licensee can be a creator that is represented by a channel identifier associated with the content sharing service, and an enforcing or verifying party can be an identifier associated with the content sharing service.

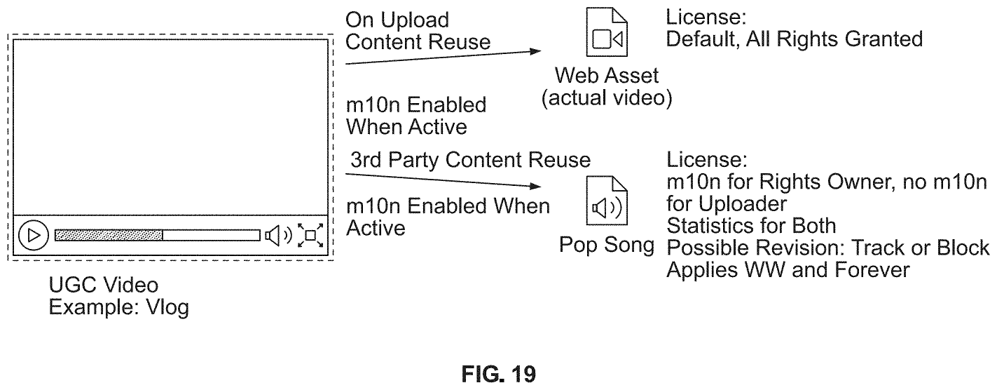

It should be noted that claim actions and policy definition can be part of a license. For example, as shown in FIG. 19, there are two instances of content reuse and each instance of content reuse has a license—e.g., the creator that uploaded the content item to the content sharing service has a default license for the creator granting them all of the rights in which there is monetization of the web asset for the creator and the partner that owns the rights to the pop song in which there is monetization for the partner on the usage of the pop song asset and there is no monetization for the creator of the video.

### Partners and License Creation

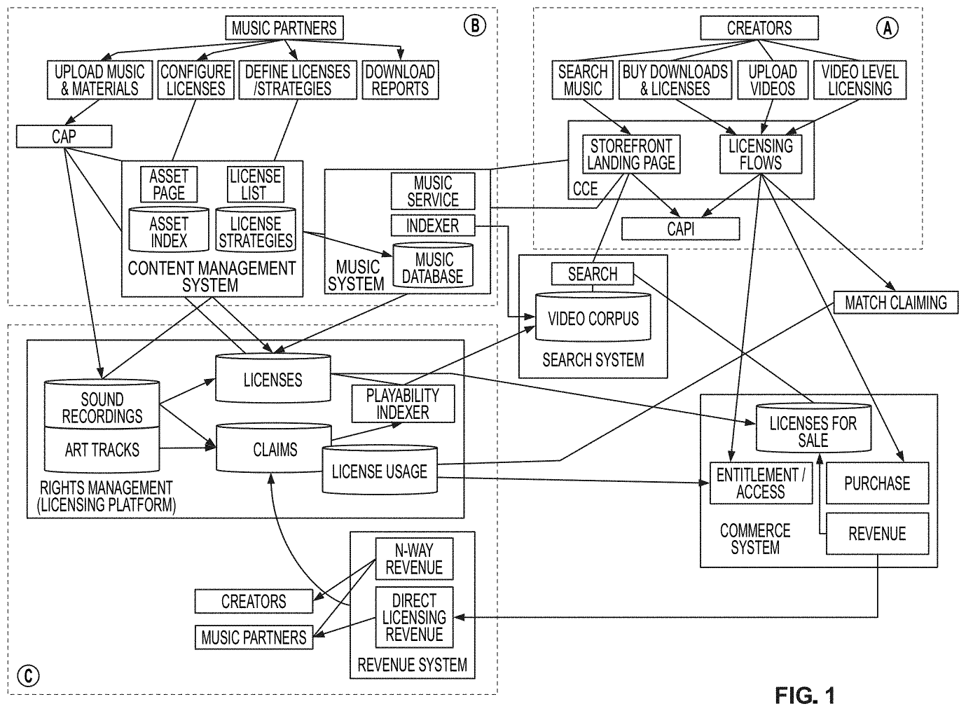

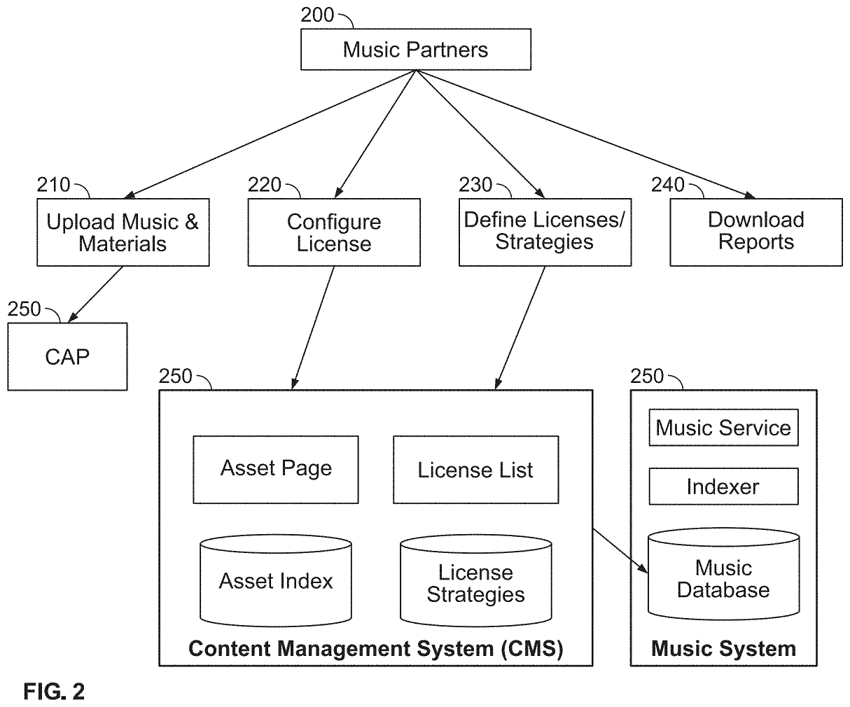

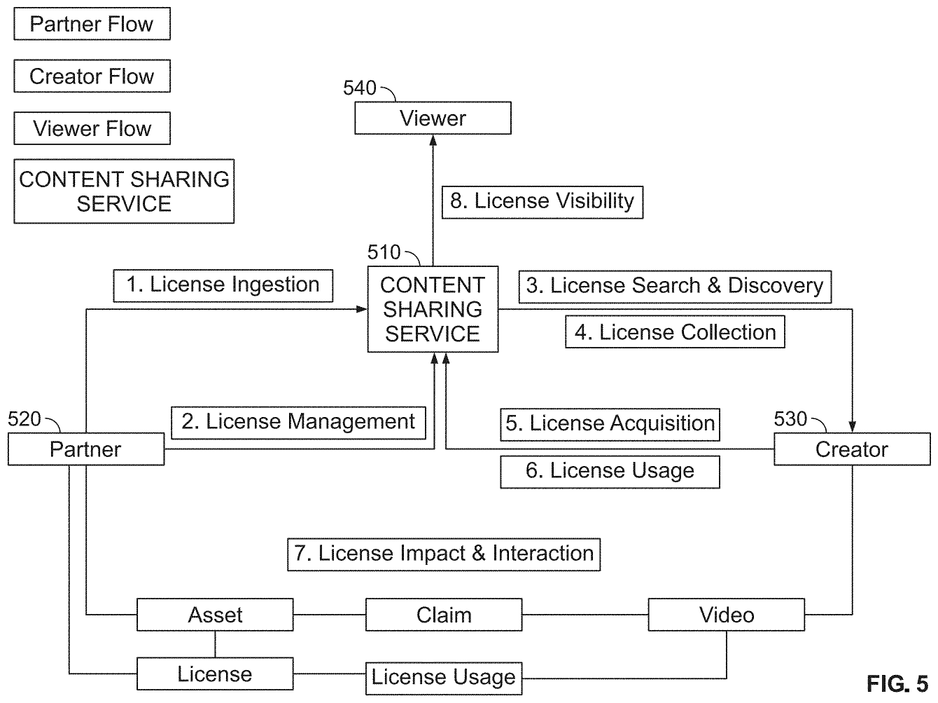

In some embodiments, the mechanisms can include a storefront for partners, such as music partners or entertainment partners, to market direct licenses of content assets to content creators. For example, as shown in FIGS. 1 and 2, a music partner 200 can be provided with user interfaces for uploading music and other content assets at 210, configure a license for such music or other content assets at 220, define license strategies at 230, and/or download reports and analytics on the use and revenue generation of such content at 240. In another example, as shown in the license flow diagram of FIG. 5, a media content platform 510 can allow a partner 520 to create and/or configure licenses for content assets or perform any other suitable license ingestion features and can allow partner 520 to manage licenses that have been created and/or configured.

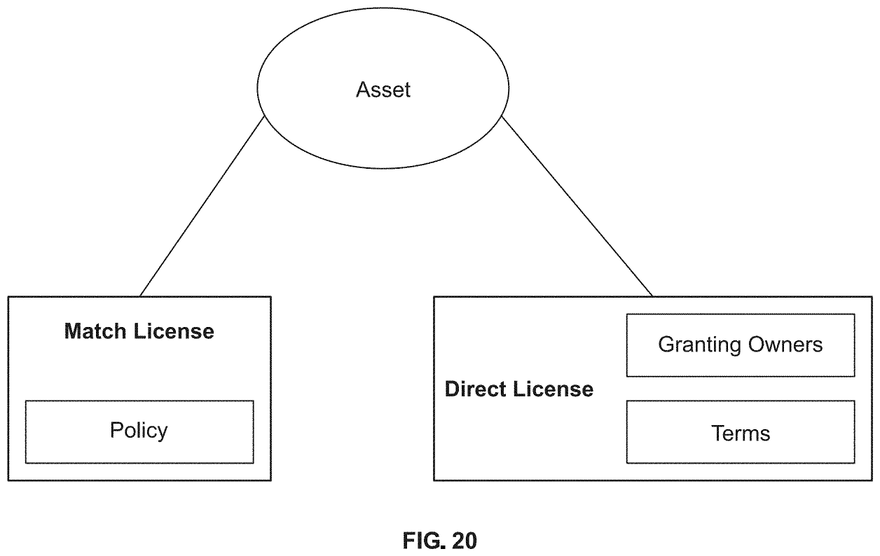

Referring back to FIGS. 1 and 2, in response to creating and/or configuring a license for a content asset, the license and associated license strategies can be transmitted to a content management system 250. In particular, as shown in FIG. 20, a license can include at least two components: license availability (e.g., whether to show the asset in the marketplace and/or whether to make the asset available for particular creators/channels) and license terms (e.g., the cost to purchase the license, how long the license is applicable for, how many usages a license is allowed to have, etc.). For example, for a particular music asset, content management system 250 can store the terms and availability of a license in a set of conditions—e.g., allow channels A, B, and C to purchase this music asset in a marketplace for $0.00 in which the license never expires, allow channels D and E to purchase this music asset in the marketplace for $1.00 in which the license expires in 1 year, and allow all other creators or channels to purchase this music asset from the marketplace for $7.50 in which the license expires in 3 years.

It should be noted that the licensing platform described herein can expand the types of licenses associated with assets. As used herein, a direct license can be acquired by a creator, where the license grants the creator certain rights to use the underlying assets in their content items. It should also be noted that a license can be acquired by one creator potentially more than one (e.g., the creator wants to use a one-use license in different videos). It should also be noted that, because the license is acquired directly between a creator and a partner, such a license remains in accordance with its issued terms even if that partner terminates its contract with the service provider that provides the marketplace for listing assets and licenses for acquisition.

Generally speaking, there can be at least three objects related to license modeling: a license, a license acquisition, and a license usage. As mentioned above, a license can be acquired by a creator, where the license grants the creator certain rights to use the underlying assets in their content items. A license acquisition is a record of a creator purchasing a license. A license usage is the action in which a creator applies an acquired license to a content item (e.g., a video). It should be noted that a license can be acquired by one creator more than one (e.g., a creator wants to use a one-use license of an asset in different videos). It should also be noted that a license acquisition can have multiple usages on different videos (e.g., when the license is a multi-use license).

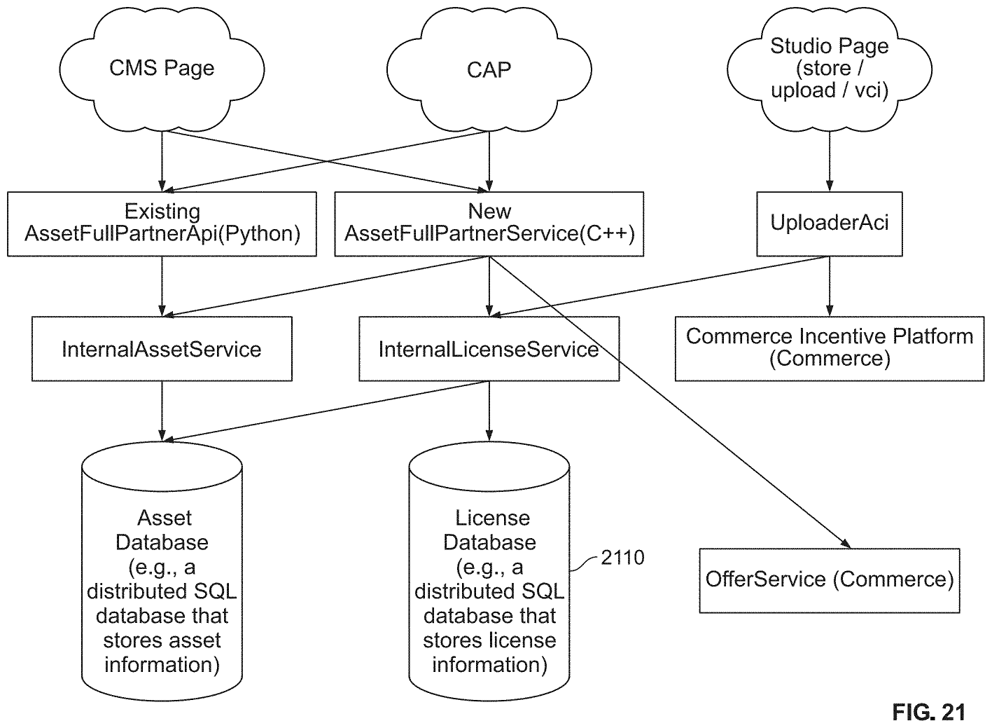

It should be noted that the mechanisms described herein can store licenses and license terms in any suitable manner. There can be at least three objects related to a license: the license itself, license acquisition records, and license usage records. For example, as shown in FIG. 21, a license and license terms (e.g., which territory this license can be used) can be stored in a table 2110. In FIG. 21, when a partner creates a license, AssetFullPartnerService can be called to create an offer. Upon successful return of that remote procedure call (RPC), InternalLicenseService can then be called to create licenses with the returned offer identifier (OfferId). It should be noted that some license information can be stored and/or duplicated in additional components. For example, license table 2110 can store a key to reference canonical data, such as an ItemId that corresponds to a license of an asset or any other piece of goods to be sold and an OfferId that corresponds to an offer as to how, where, and when the license of the asset can be acquired by a creator, while pricing information can be stored on a commerce backend component. In another example, license acquisition records can be stored on the commerce backend component as entitlements.

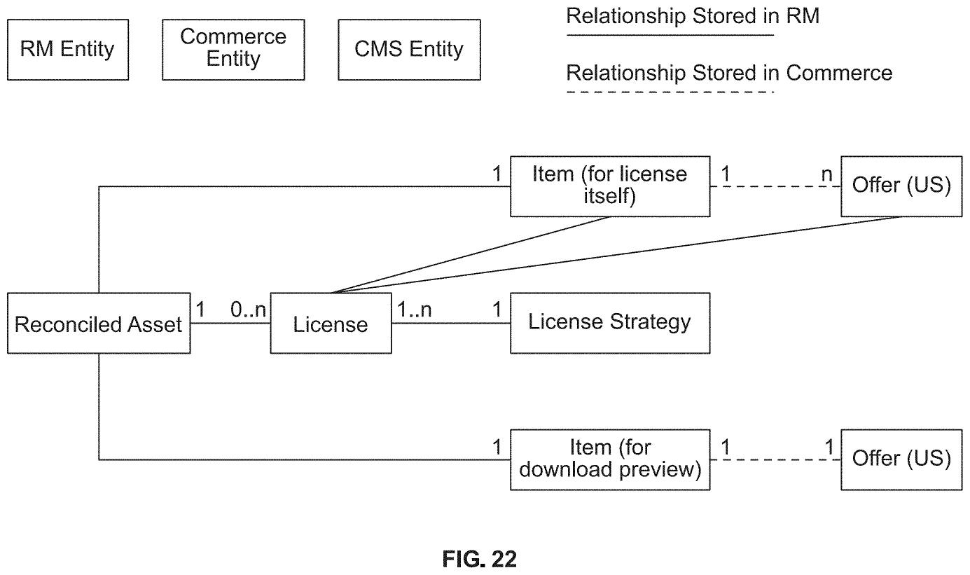

In a more particular example, FIG. 22 is an illustrative example of how various entities are related. For example, a rights management entity (RM entity) can store the reconciled asset, the licenses, the relationships between the license and its items and offers in the commerce entity, and the relationship between the license and the license strategy stored in the content management system (CMS entity). In continuing this example, the commerce entity can store the items, the offers, and the relationships between the items and offers. As shown, licenses have channel level targeting but a single price, where there may be free licenses. The “US’ in the offer means that the license is visible in the storefront to creators in the United States only. There can be two items per reconciled asset—one for the license itself and one for the downloaded preview. For the item for license, it may have multiple offers (e.g., 1 to n), where one offer corresponds to one license. For example, if the reconciled asset has three licenses, there can be one item and three offers in FIG. 22.

In some embodiments, each license can be assigned a unique license identifier that acts as a primary key. When a partner wants to publish a license for an asset, the mechanisms can first call the commerce entity's (InsertOfferListForItem) RPC, and update the license table upon the previous RPC's successful return. In some embodiments, a strategy identifier can be stored to denote when the license was populated. The relationship between a strategy and the terms can be maintained by the CMS entity. When creating licenses, the CMS entity can pass populated license terms and the license strategy identifier to an RM entity. Any rights management-specific information can be stored in the license table, while storing the general commercial information in the Offer. When the marketplace needs to fetch a license, the necessary identifiers can be returned for the marketplace to communicate with the commerce entity. For example, the Offer can include pricing, country (where this can correspond with the country where the license can be made available in the storefront, not where the license can be used), and license available time in storefront (which corresponds to the “time availability in store”). In some embodiments, a tag field can be used for channel targeting. For example, if this offer can only be purchased by channels with more than 10 million subscribers, this tag can be a string of “channel:>10M” or “channel_id=12345.” When presenting licenses that can be acquired in the storefront, the mechanisms can call MultiGetSelectedOfferDetails with the item identifier, and a tag crafted on-the-fly based on the subscriber count of current channels.

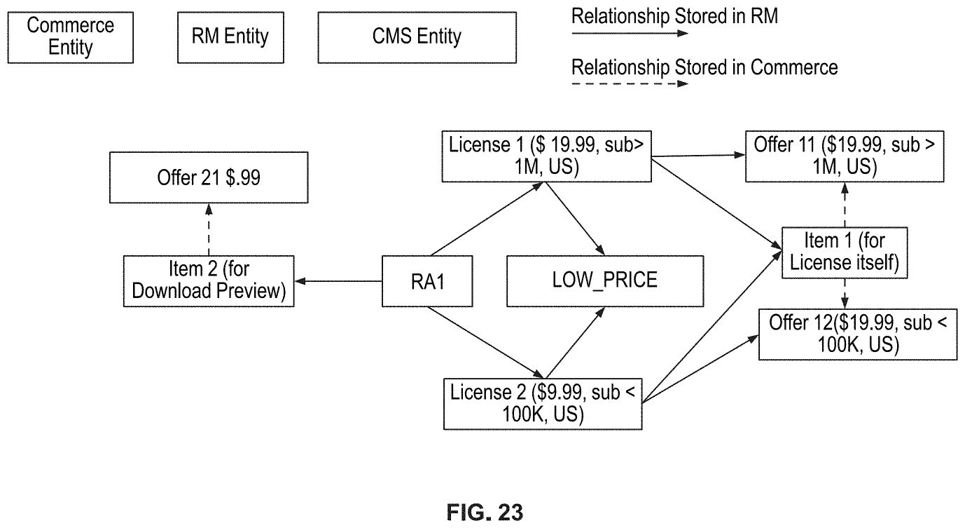

Another more particular example is shown in FIG. 23 in which a partner wants to issue licenses on their reconciled asset (RA1) with a “Low Price” strategy, meaning that there will be 3 licenses: a $19.99 license for popular creators, a $14.99 license for medium creators, and a $9.99 license for smaller creators. These three licenses can include additional terms, such as perpetuity versus fixed length. There can be downloadable previews as well, where downloads can have a uniform price tag. It should be noted that, in some embodiments, even if the asset does not have any available license associated with it, the asset may have a download preview. For example, the partner can provide a creator with the ability to download the asset and insert at least a portion of the asset into a content item using an editor (e.g., a video editing application) to assist the creator in determining whether to acquire a license to that asset using the storefront.

It should be noted that one asset can correspond to multiple licenses because these licenses may have different terms. Each license can correspond to exactly one offer. Note also that one asset corresponds to one item. In some embodiments, however, when one license contains multiple assets, one license can correspond to one item and some assets may appear in multiple items. As creators can be permitted to download the asset for previewing (e.g., with or without a fee), corresponding items and offers can be created for previewing the asset.

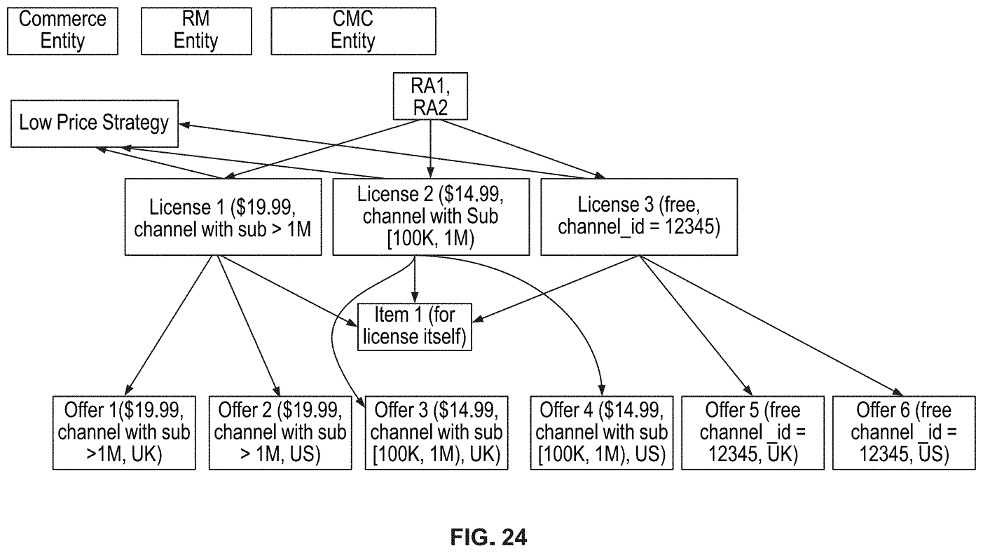

Yet another more particular example is shown in FIG. 24 in which a partner wants to issue licenses on their reconciled assets (RA1 and RA2). As shown, one strategy (a Low Price strategy) has multiple licenses (License 1, License 2, and License 3). For example, License 1 can be provided to a creator with a channel or a page having more than one million subscribers, License 2 can be provided to a creator with a channel or page having between one hundred thousand subscribers and one million subscribers, and, alternatively, License 3 can be provided to a creator at no cost to the creator. Note that each offer can be on a per-country basis. For example, Offer 1, Offer 3, and Offer 5 indicate that the license is available for acquisition in the UK storefront, while Offer 2, Offer 4, and Offer 6 indicate that the license is available for acquisition in the US storefront.

It should be noted that, although the embodiments described herein generally describe licenses for assets as being stored in a separate table, this is merely illustrative. In some embodiments, licenses can be stored as part of assets.

### Creators and License Acquisition

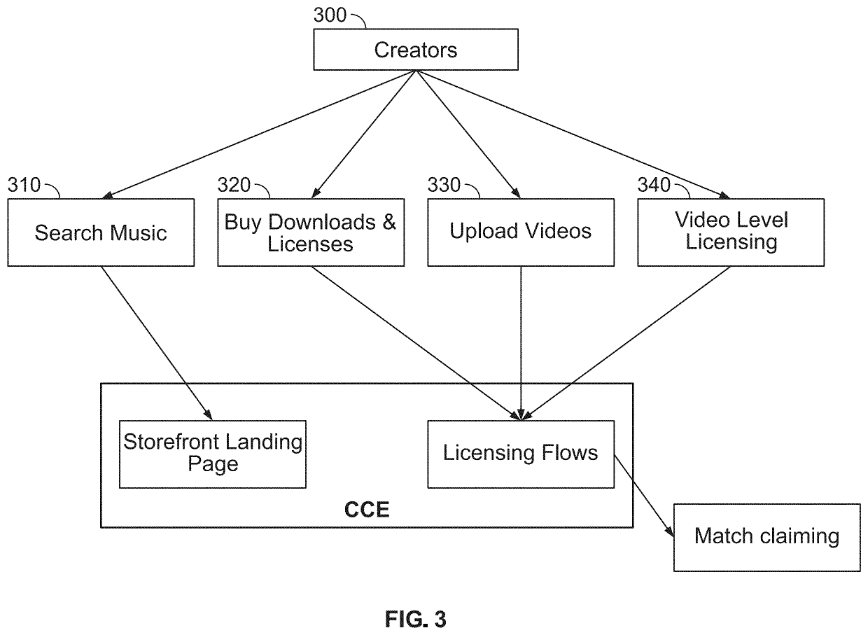

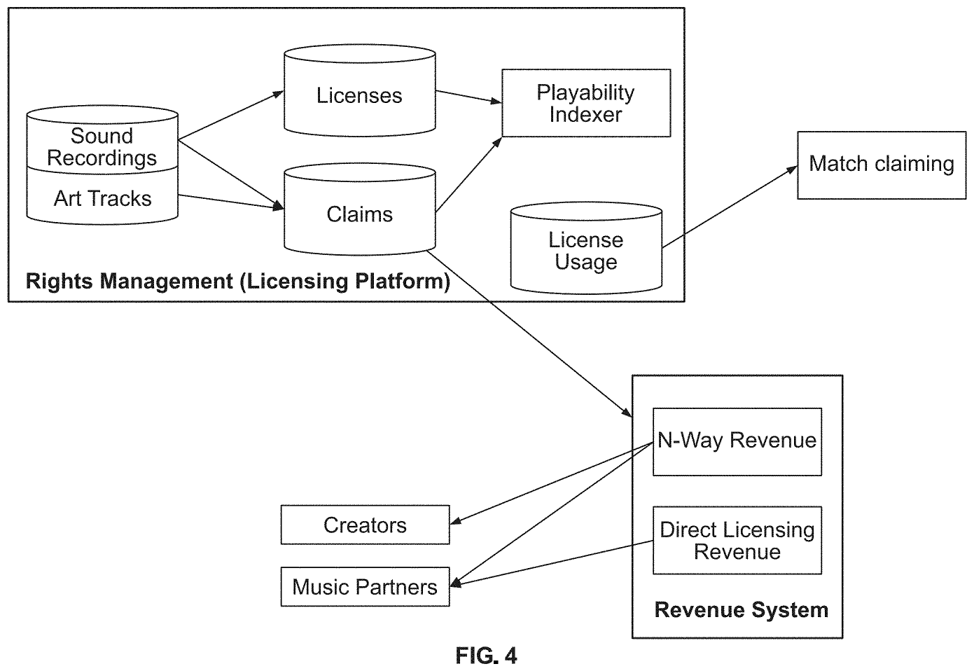

In some embodiments, the mechanisms can include a marketplace for creators that allows a creator to acquire one or more direct licenses of content assets from partners. For example, as shown in FIGS. 1 and 3, a creator 300 can be provided with user interfaces for searching for assets (e.g., music assets) at 310, acquiring downloads and licenses of assets at 320, uploading content items (e.g., videos) to a content sharing service at 330, and/or perform video level licensing in applying acquired licenses to one or more content items at 340. In another example, as shown in the license flow diagram of FIG. 5, a media content platform 510 can present available licenses from one or more partners to a creator 530 for acquisition, can allow creator 530 to manage the licenses of assets that have been acquired from one or more partners, can allow creator 530 to acquire licenses of assets from one or more partners, and can allow creator 530 to use or otherwise apply an acquired licensed of an asset on a content item.

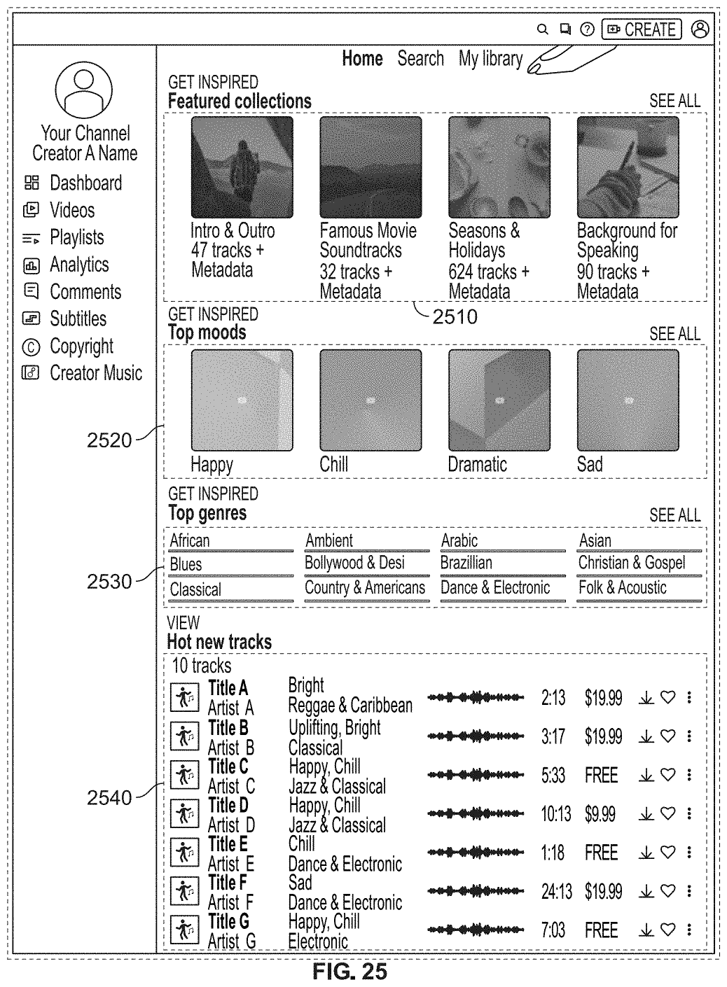

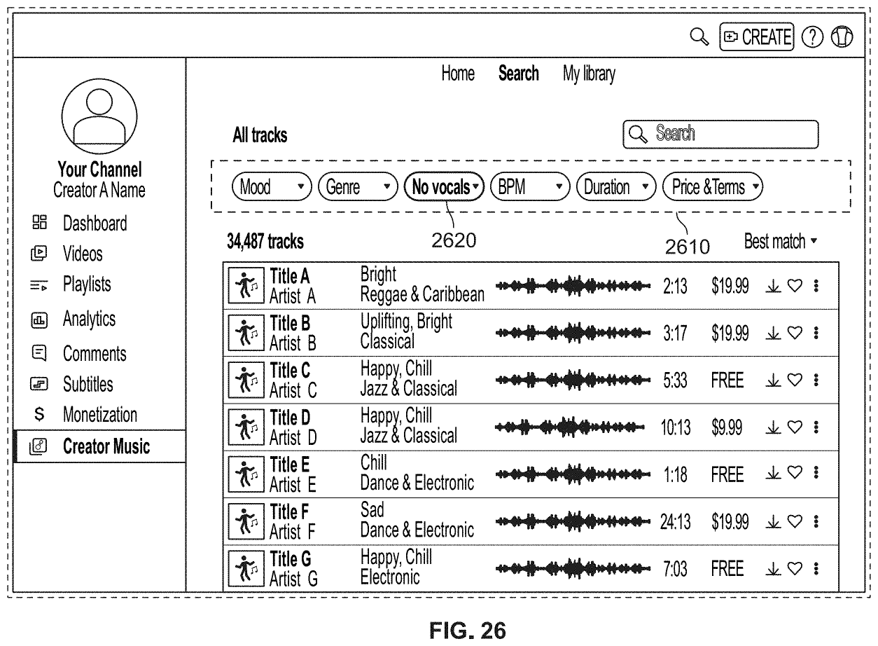

FIGS. 25 and 26 show illustrative examples of a storefront home page that can be provided to a creator for acquiring one or more direct licenses of assets from partners. As shown in FIG. 25, multiple list modules for selecting playlists 2510 (e.g., an adventure playlist), moods 2520 (e.g., a calm mood, a happy mood, etc.), genres 2530 (e.g., rock, ambient, country, etc.), and tracks 2540 that have been filtered for “is latest & hot” assets can be provided to a creator. As shown in the listing of filtered assets, each available asset for which a license can be purchased can be represented with a thumbnail image (e.g., album art), a title, an artist name, a mood, a genre, a total playback time, a waveform visualization interface that allows a creator to navigate through and playback the asset, and a price for acquiring a license (e.g., $19.99 for Title A by Artist A, no cost for Title C by Artist C, and $9.99 for Title D by Artist D). For example, the waveform visualization information can allow the creator to select a particular point on the waveform representation and, in response to the selection, plays back a portion of the asset that corresponds to the selected point on the waveform representation. This can, for example, allow the creator to receive a preview of the asset prior to purchasing a license. It should also be noted that, as described above, the price for acquiring a license to an asset can be determined based on the account associated with the creator (e.g., a creator having a channel identifier that is associated with a particular number of subscribers).

As shown in FIG. 26, multiple filters 2610 can be provided that allow the creator to select one or more filter options to review a subset of available assets for acquiring a license. For example, a creator using the storefront can select one or more filters, such as “free” to use and “calm” mood, to receive a subset of available assets for download and/or application into a content item. In another example, as shown in FIG. 26, filter 2620 has been selected and configured to obtain a subset of available assets for acquiring a license in which each asset does not contain vocal content.

It should be noted that any suitable filter can be provided to allow the user to review a subset of available assets for acquiring a license. Such filters can include filtering by genre, mood, duration, vocalness, license attributes (e.g., licenses available for purchase versus revenue sharing, free versus paid, price), etc.

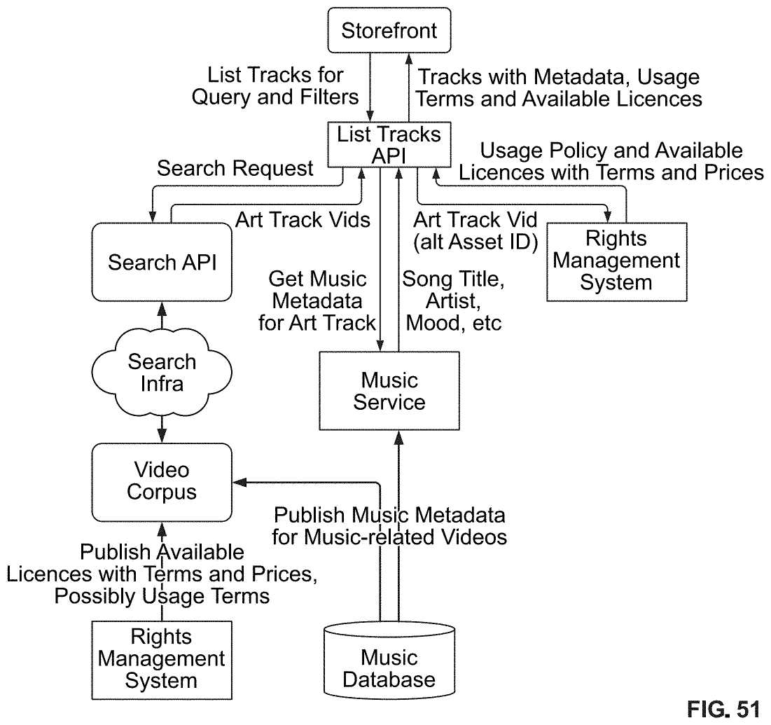

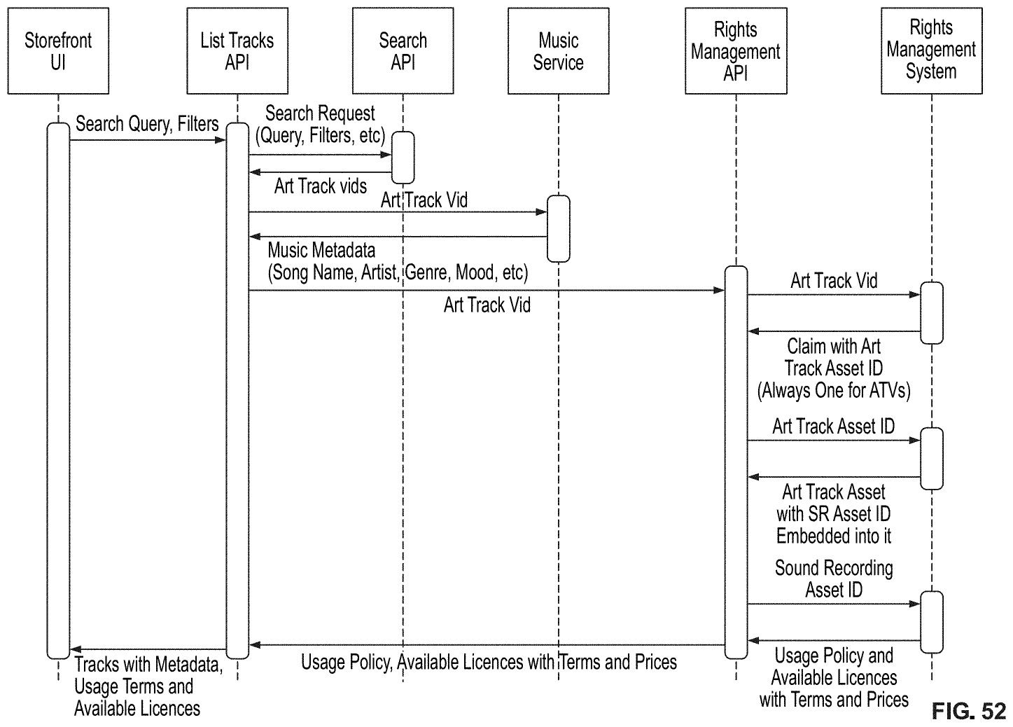

An illustrative architecture showing how the storefront mechanisms provide the asset and associated license information in the one or more user interfaces is shown in FIG. 51 and an illustrative flow diagram showing how the storefront user interface is used to transmit a search query or filter selections and, in response, receives assets with metadata, usage terms, and available licenses is shown in FIG. 52. For example, as shown in FIGS. 51 and 52, in response to receiving a search query including particular search terms (e.g., an artist name, a genre or category name, etc.) and/or one or more filter selections (e.g., a filter to retrieve calming songs, a filter to retrieve songs in a pop category, etc.) in a storefront user interface, a list tracks application programming interface can generate a search request for transmission to a search system (e.g., a search application programming interface), where the search system can return content identifiers or other suitable content information for content matching the received search request. In turn, the list tracks application programming interface can transmit the received content identifiers or other suitable content information to a music service to obtain corresponding metadata (e.g., a song name, an artist name, a genre, a mood, etc.). The list tracks application programming interface can then communicate with a rights management system by inputting the content identifiers or other suitable content information for content matching the received search request into a rights management application programming interface, which retrieves a claim with an artist track asset identifier, an artist track asset with a sound recording (SR) asset identifier embedded within it based on the artist track asset identifier, and usage policy and available licenses with license terms and license prices based on the sound recording asset identifier. The usage policy and available licenses with license terms and license prices can be returned to the list tracks application programming interface, which can update the content matching the search query (e.g., songs) in the storefront user interface with the music metadata from the music search and with the usage terms, available licenses with license terms and license prices from the rights management system.

In some embodiments, the storefront mechanisms can provide the creator with an opportunity to download an asset to try out in a local editor for incorporation into a content item (e.g., insert a song into the background using a video editor) prior to purchasing the license.

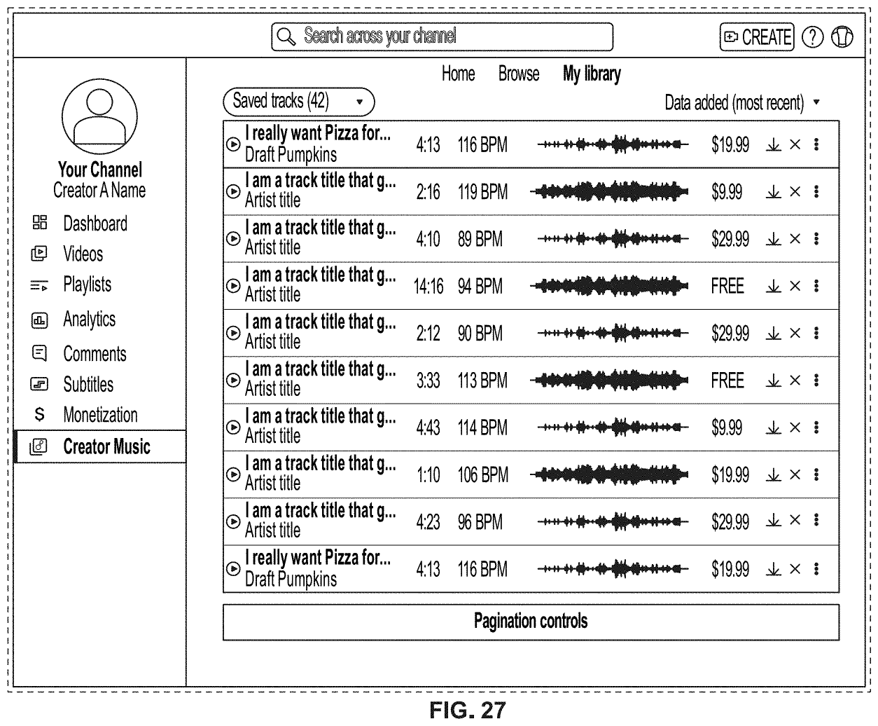

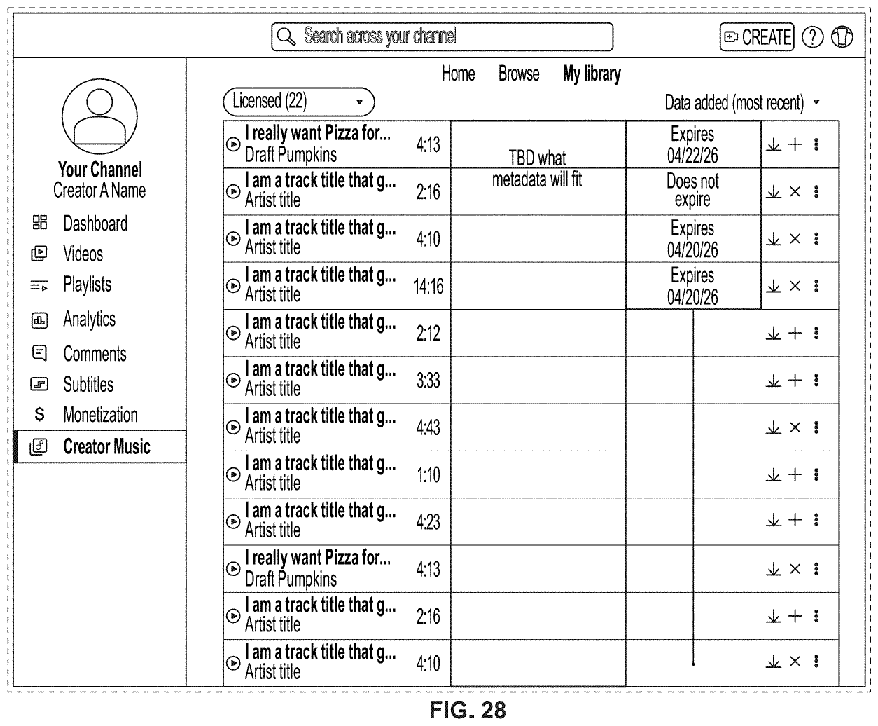

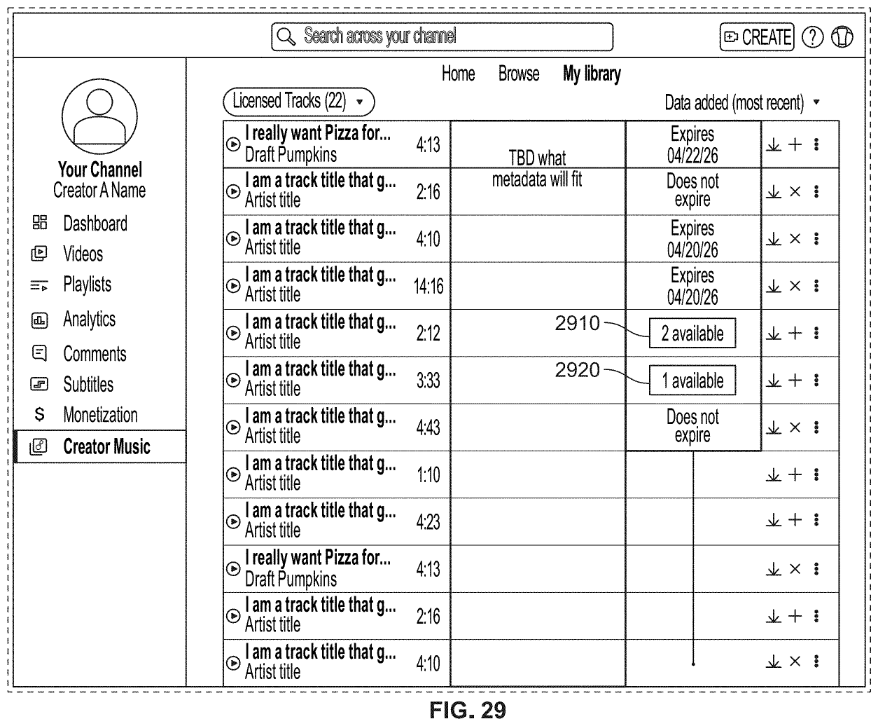

In some embodiments, the storefront mechanisms can provide the creator with a library of assets. For example, FIG. 27 provides an illustrative example of a storefront interface in which the creator is provided with saved tracks. This can include, for example, a listing of assets that the creator has previously indicated an interest in acquiring a license. As shown in FIG. 28, the storefront mechanisms can provide the creator with a library of licensed assets in which license term information is presented (e.g., expiration dates associated with each licensed asset). For example, as shown in FIG. 28, one or more of the assets in which a license has been acquired can have a license that expires at a particular time. In another example, as also shown in FIG. 28, one or more of the assets in which a license has been acquired can have a license that does not expire. As shown in FIG. 29, the storefront mechanisms can, in some embodiments, indicate which licenses have been purchased but have not yet been activated by applying them to content items (e.g., “2 available” for the fifth asset in the list at 2910, “1 available” for the sixth asset in the list at 2920, etc.).

In some embodiments, the storefront mechanisms can allow a creator to acquire a license to an asset when uploading a content item to the content sharing service, where the content item includes the asset.

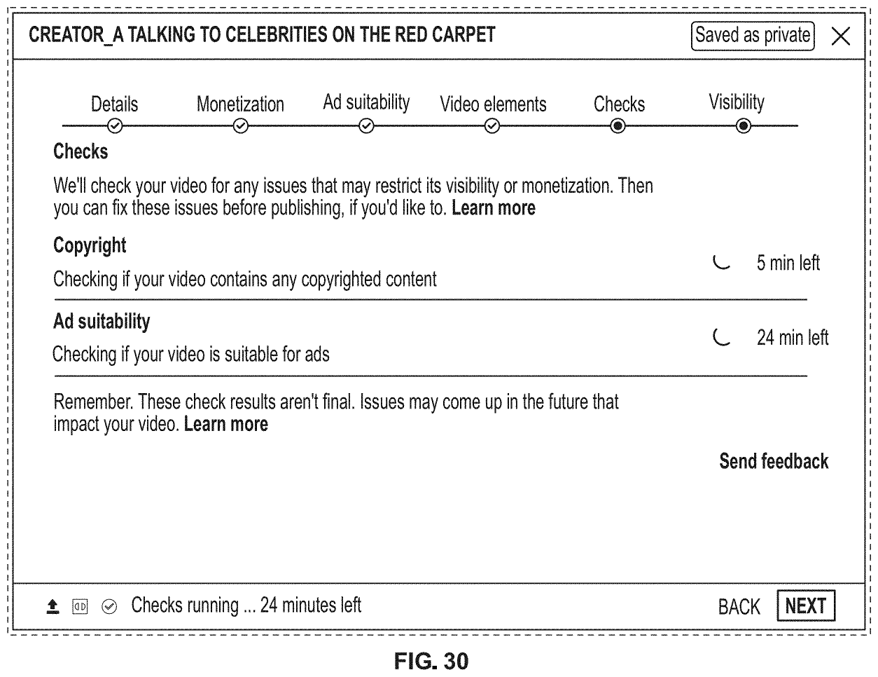

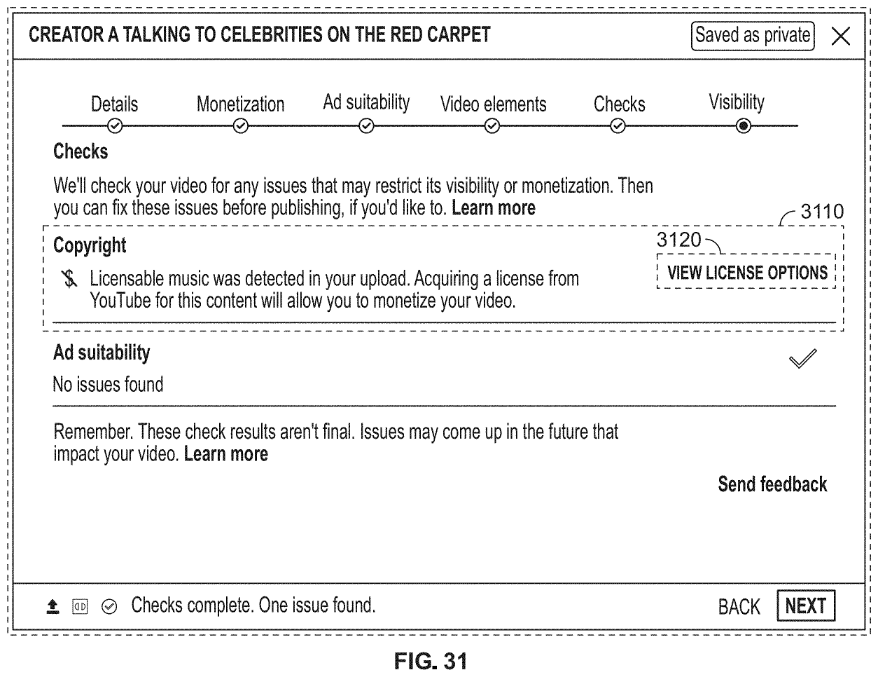

For example, as shown in FIG. 30, the storefront mechanisms can present an interface that informs the creator that, upon uploading a content item, a check is performed that searches for issues that may restrict the visibility or monetization of the content item. This can include checking if the content item contains any copyrighted content and/or checking if the content item is suitable for advertisements. As shown in FIG. 31, while no issues were found in connection with advertisement suitability, licensable music was detected in the content item at 3110. In turn, the storefront mechanisms can provide the creator with an opportunity to view license options for acquiring a license to the music that was detected in the uploaded content item (e.g., by selecting “video license options” 3120).

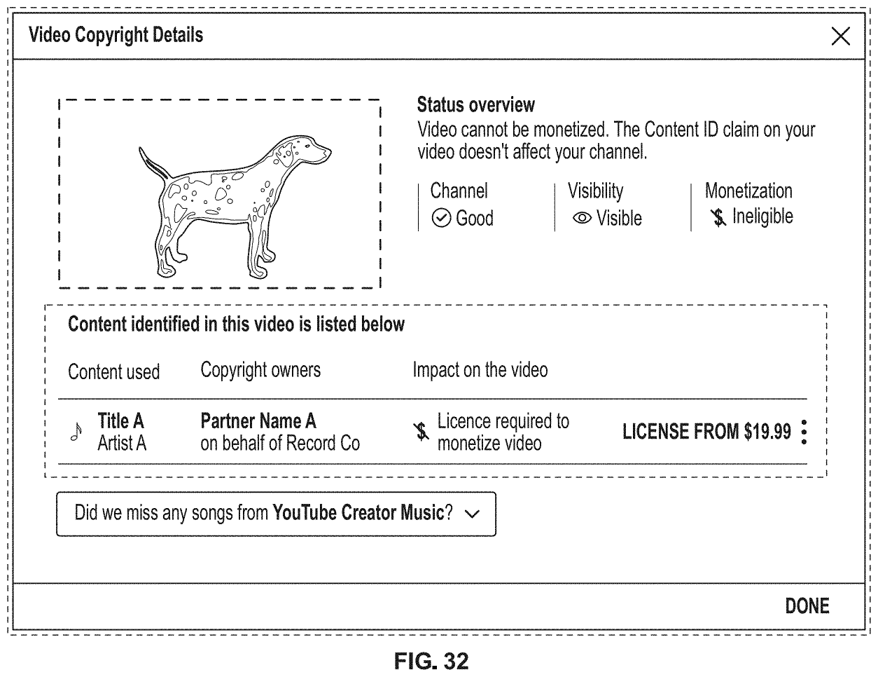

In response to selecting the “view license options” element, the storefront mechanisms can provide the creator with a status overview (e.g., that the video cannot currently be monetized) and with information relating to the asset that was identified in the content item. For example, as shown in FIG. 32, the storefront mechanisms can present the creator with information relating to the asset that was identified in the content item (e.g., the song “Title A” by the artist “Artist A”), the copyright owner of the asset (e.g., “Partner Name A on behalf of Record Co”), and the impact that including the asset has on the content item (e.g., that a license is required to monetize the content item). As also shown in FIG. 32, the storefront mechanisms can retrieve the price for acquiring a license to the asset (e.g., a license from $19.99).

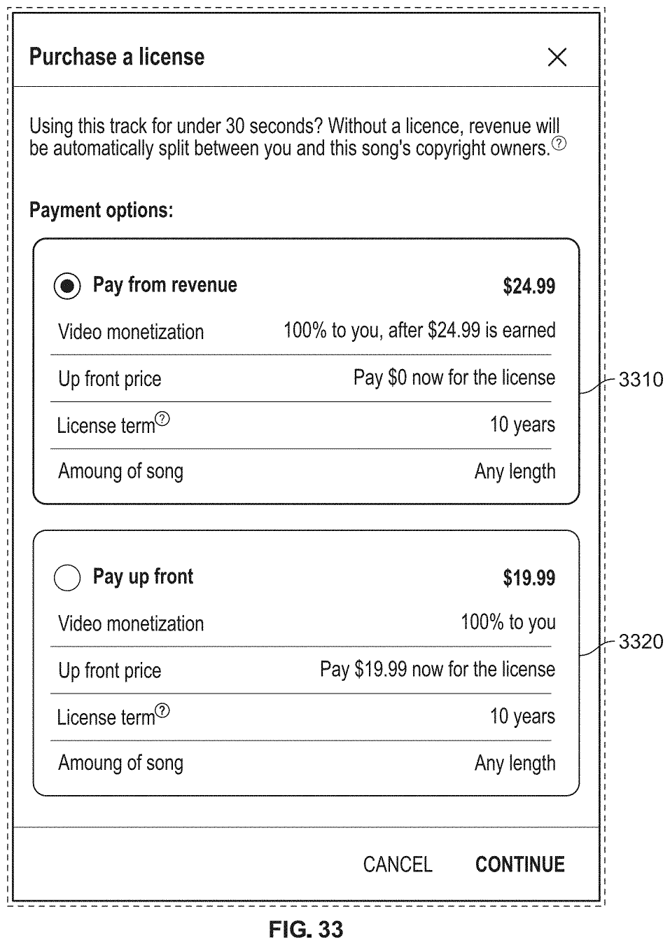

In response to the creator providing an indication to purchase a license, the storefront mechanisms can present a purchase interface in FIG. 33 that allows the creator to purchase one or more licenses having different licensing terms (e.g., pay from revenue 3310 in which the creator initially pays nothing for the license but the first $24.99 or any other suitable amount that is earned is paid to the partner, or pay up front at 3320 in which the creator pays $19.99 to acquire a ten-year license). In some embodiments, each set of license terms can provide the creator with monetization terms, price information, license term, and amount of the asset available for usage. It should be noted that, although two payment options are provided, this is merely illustrative and the storefront mechanism and/or the partner can provide any suitable number of payment options.

For example, as shown in FIG. 33, the storefront mechanisms can configure a recoupment model in which payment for a license to the asset is made from revenue. In this recoupment model, the storefront mechanisms is configured to direct video monetization payments to the partner or licensor of the asset until a particular amount has been reached (e.g., the first $24.00) and then direct all of the additional video monetization payments to the creator of the content item.

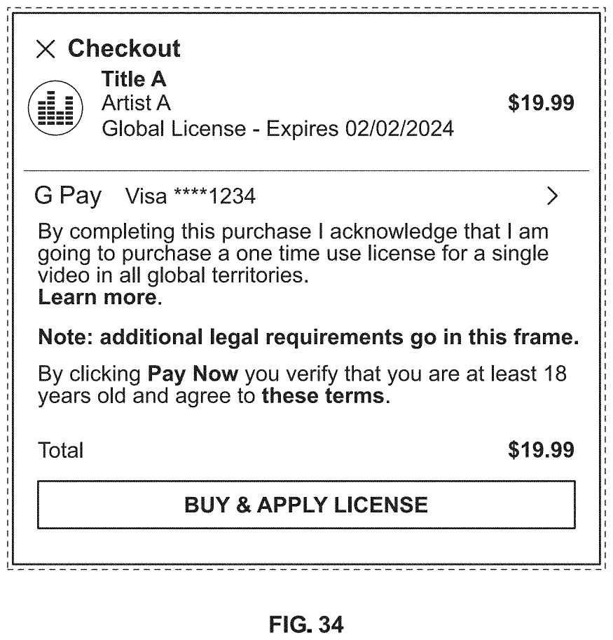

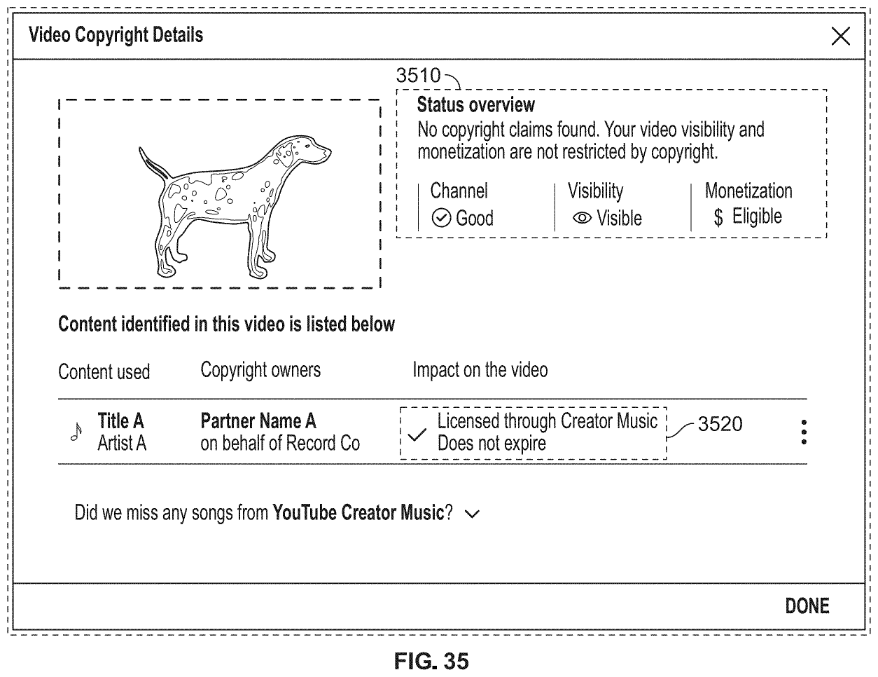

In response to the creator selecting a set of licensing terms, the storefront mechanisms can present a payment interface in FIG. 34 that allows the creator to use a linked electronic payment account to acquire a direct license to the asset. FIG. 35 shows that the acquired license can be applied to the content item. For example, in a status overview section 3510, the above-mentioned checks can be updated to indicate that no copyright claims have been found and that video visibility and monetization are not restricted by copyright. In a more particular example, FIG. 35 also indicates the impact of the license on the content item in a license impact section 3520 that can include license acquisition information, license application information, and/or license term information—e.g., that a license for the asset has been acquired from a partner, that the license has been applied to the content item, and that the license does not expire.

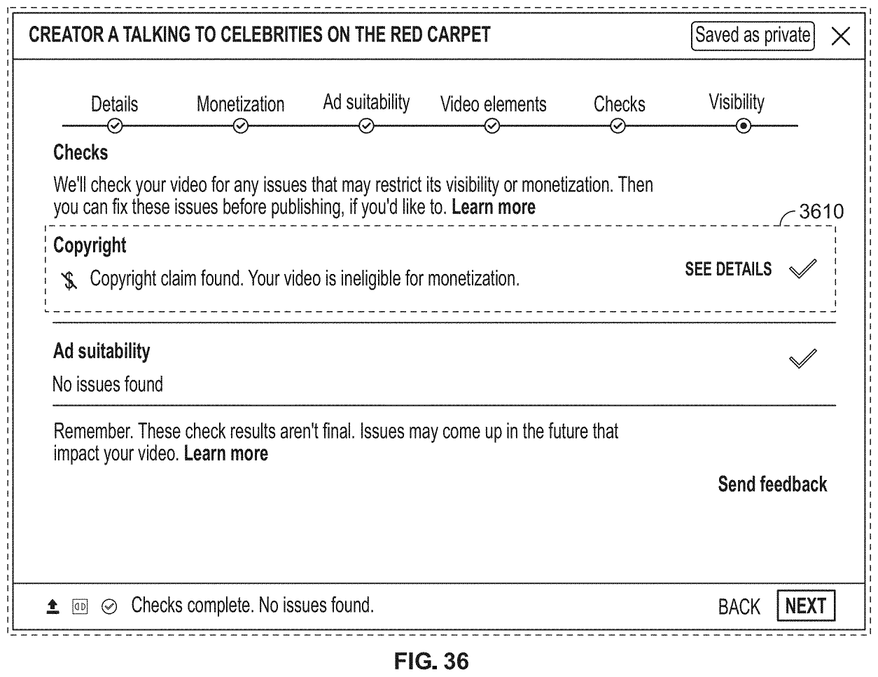

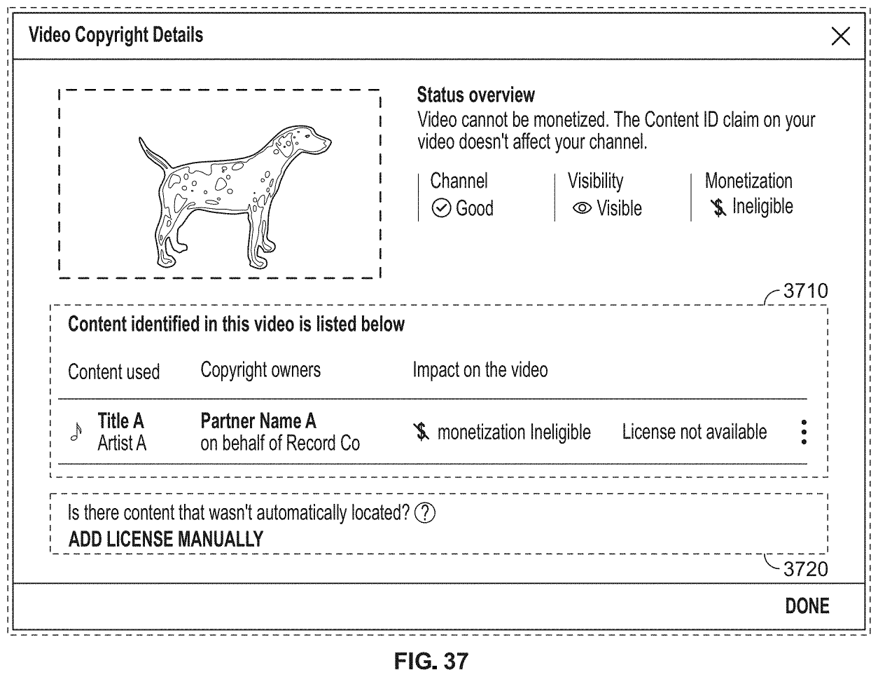

Alternatively, as shown in FIG. 30, the storefront mechanisms can present an interface that informs the creator that, upon uploading a content item, a check is performed that searches for issues that may restrict the visibility or monetization of the content item. As shown in FIG. 36, while no issues were found in connection with advertisement suitability, a copyright claim was detected in which a license is not available for the asset detected in the content item at 3610. In turn, the storefront mechanisms can provide the creator with a status overview (e.g., that the video is ineligible for monetization) and with information relating to the asset that was identified in the content item for which a license is not available for acquisition from the content sharing service. For example, as shown in FIG. 37, the storefront mechanisms can present the creator with information relating to the asset that was identified in the content item (e.g., the song “Title A” by the artist “Artist A”), the copyright owner of the asset, and the impact that including the asset has on the content item (e.g., that a license is required to monetize the content item) in content section 3710. As also shown in FIG. 32, the storefront mechanisms can retrieve the price for acquiring a license to the asset (e.g., a license from $19.99). Additionally or alternatively, the storefront mechanisms can provide the creator with recommendations that, if applied, may make the content item eligible for monetization (e.g., edit the content item to remove the copyrighted asset, change or replace the background audio from the copyrighted asset to a licensable asset, add a license manually, etc.).

In some embodiments, the storefront mechanisms can provide the creator with an interface for inputting license information associated with the content identified in the video. For example, as shown in an input section 3720 of FIG. 37, the storefront mechanisms can provide the creator with a link to input license information associated with content that was not automatically identified—e.g., content identification information, copyright owner information, license information, etc.

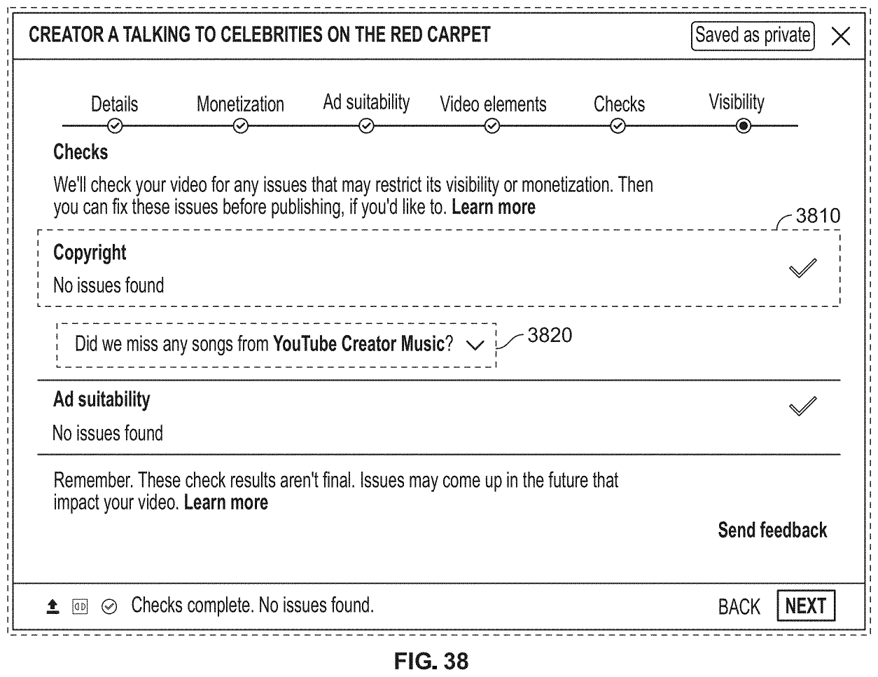

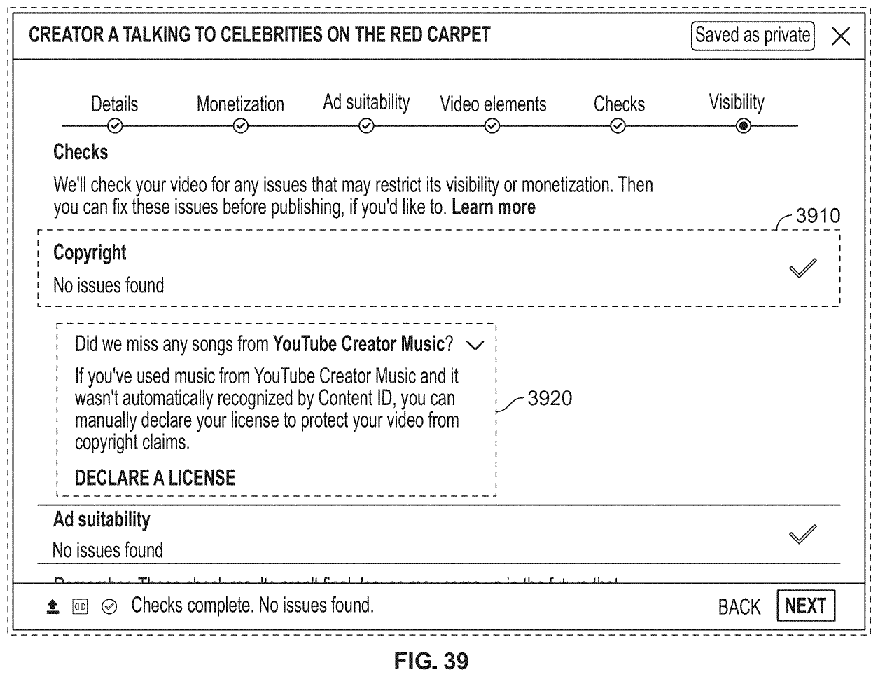

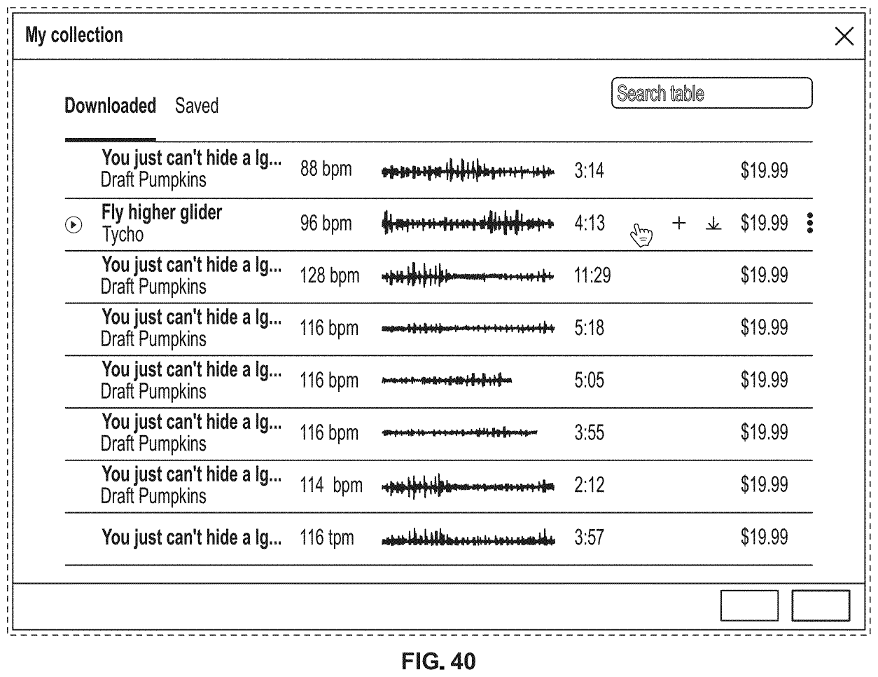

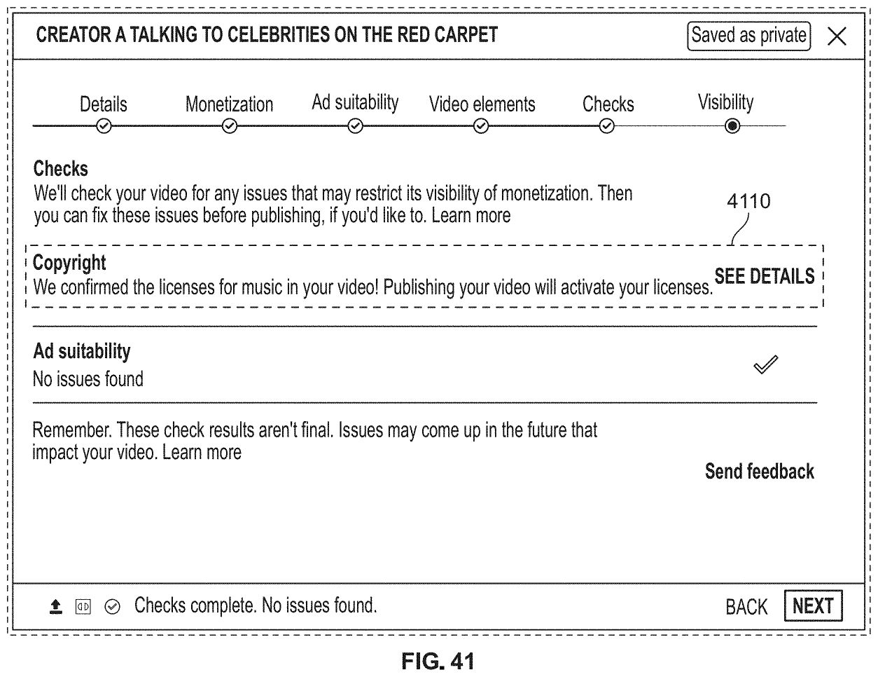

Alternatively, in FIGS. 38 and 39, in response to not detecting any copyright issues that would restrict visibility or monetization of the content item (see, e.g., section 3810 in FIG. 38 and section 3910 in FIG. 39), the storefront mechanisms can present an interface element that allows the content creator to indicate an asset within the content item that may not have been detected (see, e.g., section 3820 in FIG. 38 and section 3920 in FIG. 39). In response, as shown in FIG. 39, the storefront mechanisms can allow the content creator to manually declare a license to protect the content item from being subject to a copyright claim at a later time. For example, if the creator is aware of an asset within the content item that may have a copyright claim and that may not have been detected by the detection mechanisms, the storefront mechanisms can allow the creator to declare a license that the creator has acquired from a suitable partner. In continuing this example, as shown in FIG. 40, the storefront mechanisms can provide an interface that allows the creator to select from one or more downloaded and/or saved assets for inserting or declaring a license in a content item. Similar to the interfaces shown in FIGS. 32-34, the storefront mechanisms can allow the content creator to manually declare a license by purchasing and applying a license to the asset. As shown in FIG. 41, the storefront mechanisms can indicate, in a section 4110, a confirmation of the licenses for the assets in the content item and, upon publishing the content item, the licenses for the assets can be activated.

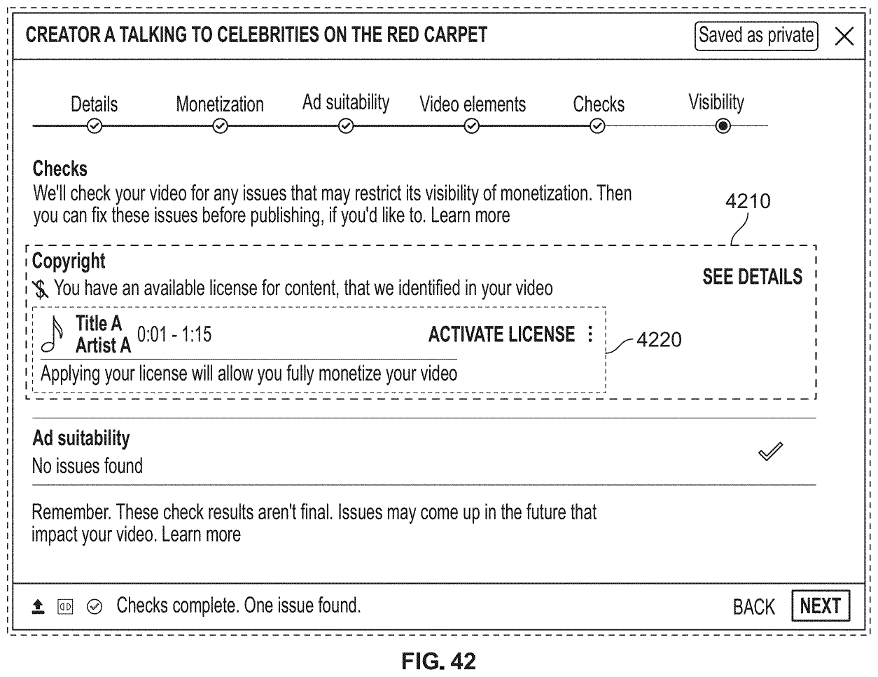

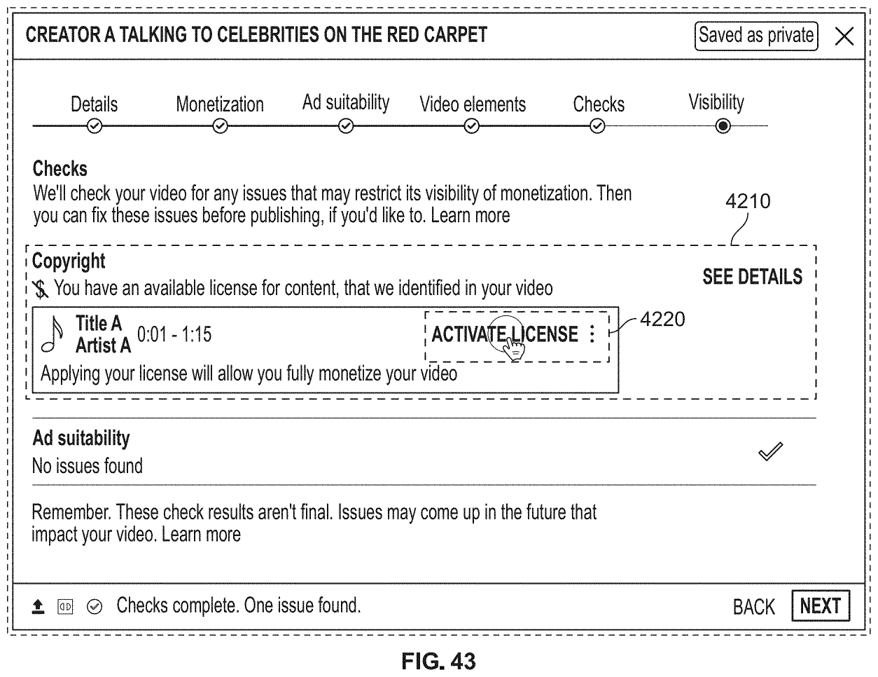

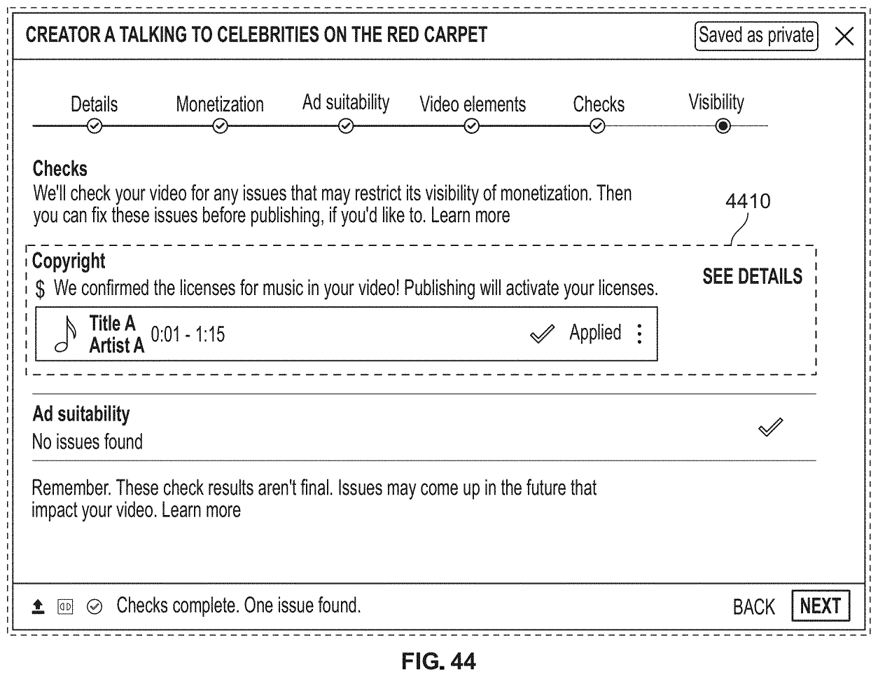

In instances in which a license has already been purchased for an asset detected within a content item, the storefront mechanisms can automatically populate the copyright check portion 4210 of the user interface in FIG. 42 to indicate that a previously acquired license is available for the asset that was identified within the content item. In response to selecting an element, such as “Activate License” link 4220 shown in FIGS. 42 and 43, the storefront mechanisms can apply the license for the asset to the content item, thereby allowing the creator to monetize the content item. For example, FIG. 44 shows that the storefront mechanisms have updated copyright check portion 4410 to indicate that the license for the song “Title A” by the artist “Artist A” has been applied to the content item uploaded by the creator.

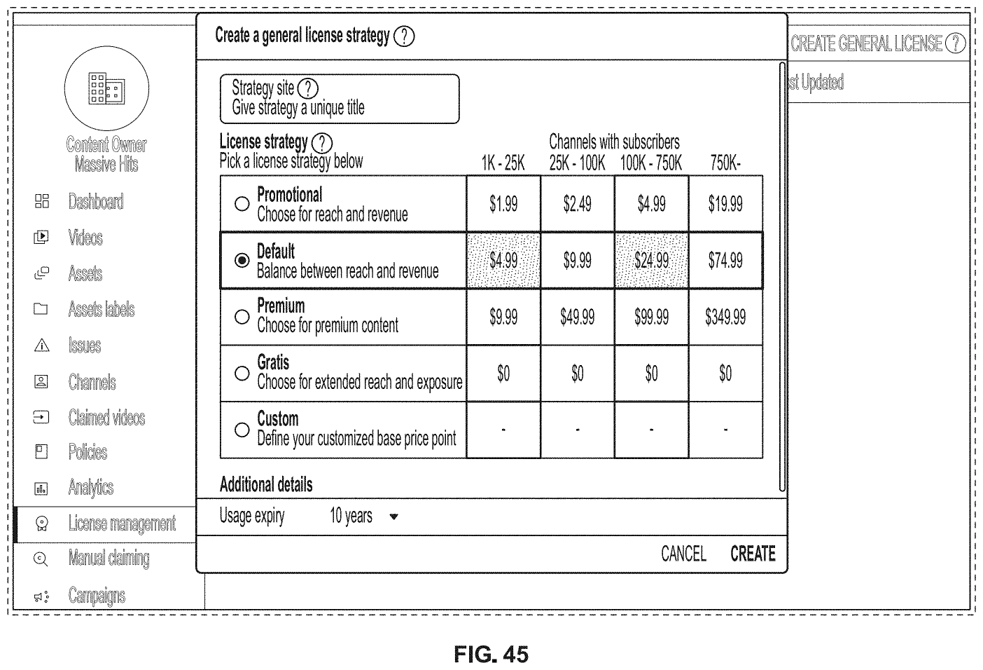

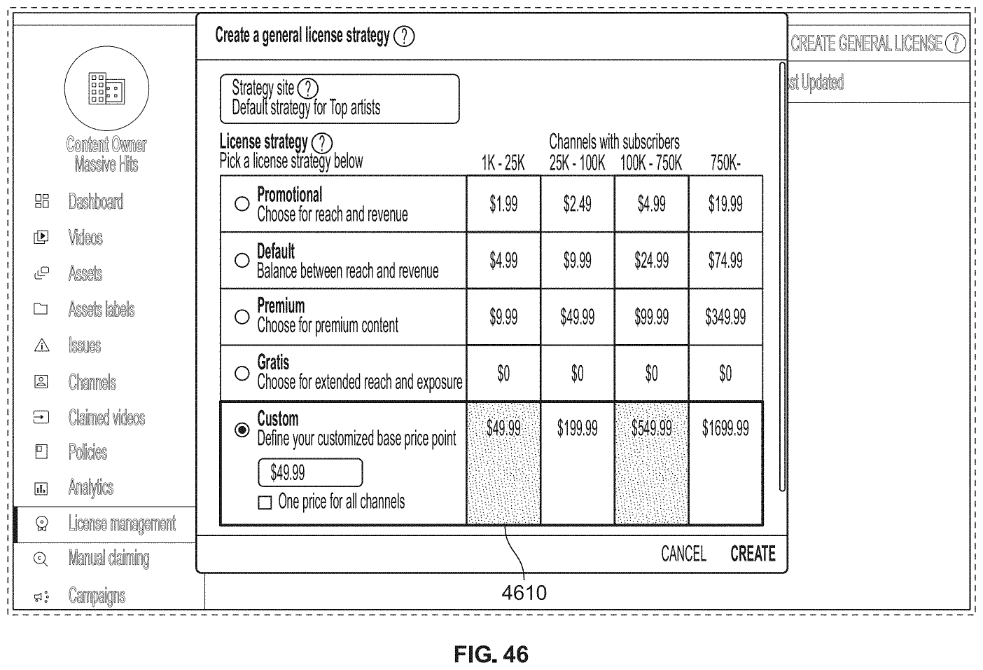

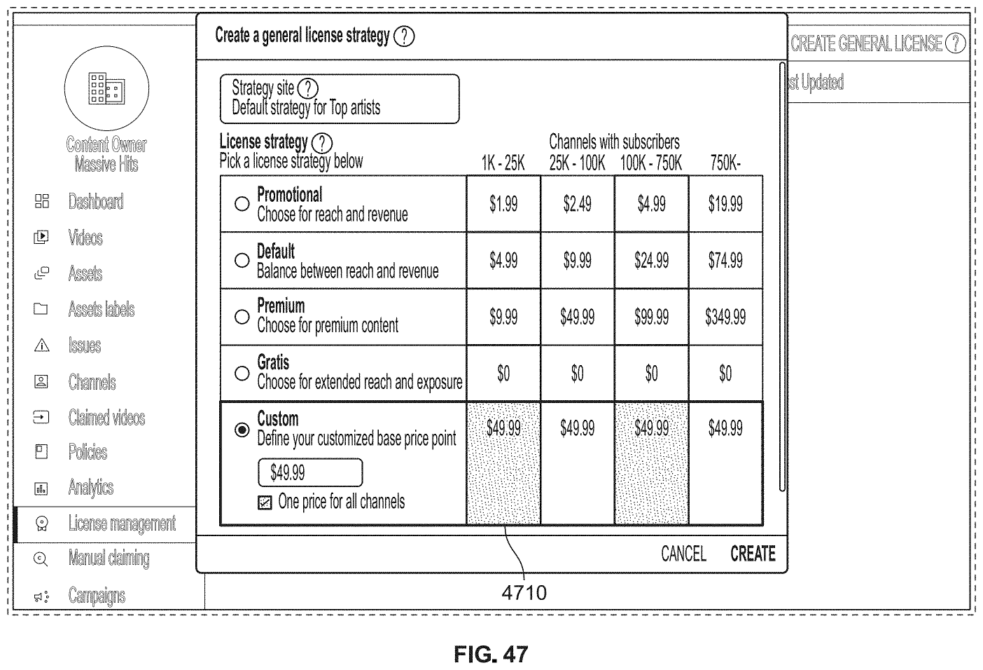

As described above, the storefront mechanisms can also allow a partner to upload assets that can be licensed for use, licenses including license availability and license terms, and license strategies. For example, as shown in FIG. 45, the storefront mechanisms can provide an interface that allows a partner to create a general license strategy. In a more particular example, a license strategy can include different prices based on the number of subscribers associated with a channel identifier of the content creator. In another more particular example shown in FIGS. 46 and 47, a custom license strategy can be created by a partner in which the partner can, among other things, define a customized base price point or set a price for all channels. As shown in section 4610 of FIG. 46, the custom license strategy can include different license terms based on the audience size (e.g., number of subscribers) associated with a creator that is seeking to acquire a license (e.g., a channel or a user account associated with a content provider platform). Alternatively, as shown in section 4710 of FIG. 47, the custom license strategy can include the same license terms regardless of audience size associated with a creator that is seeking to acquire a license (e.g., one license price for all channels).

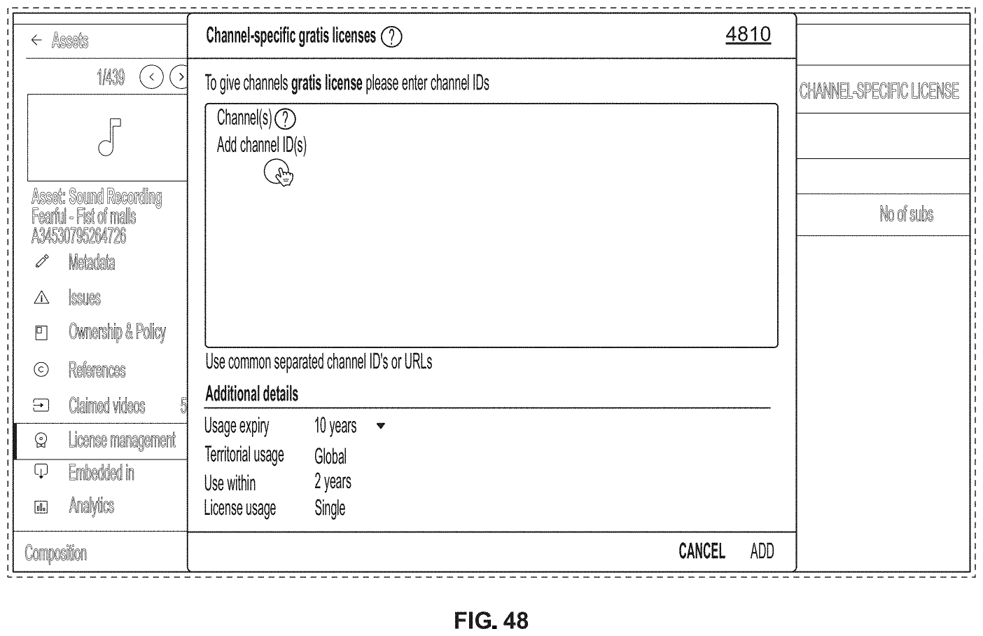

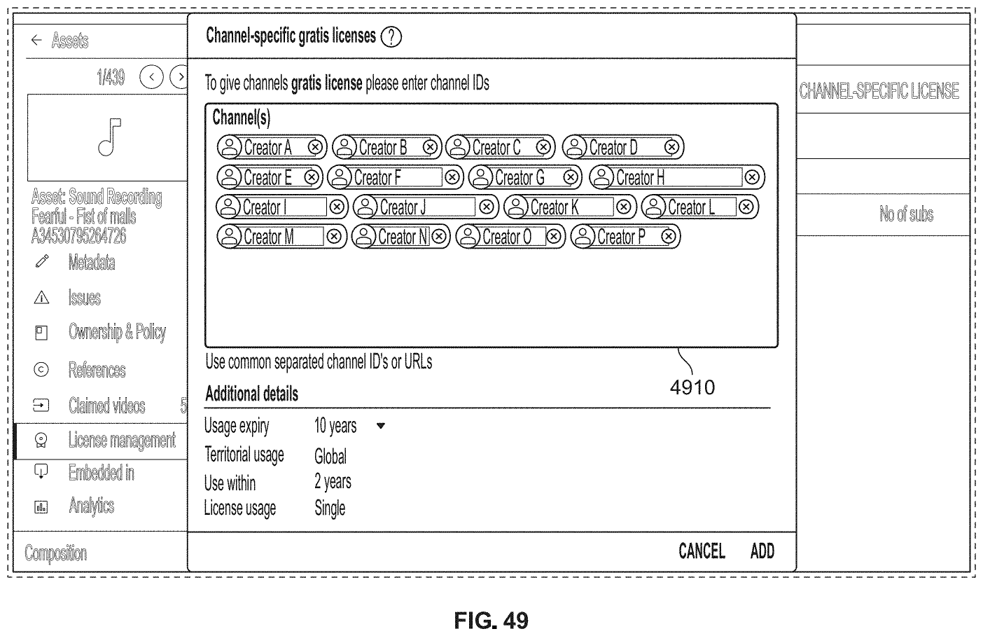

In some embodiments, the storefront mechanisms can allow a partner to provide channel-specific gratis licenses. For example, as shown in FIG. 48, the storefront mechanisms can provide the partner with a gratis license interface 4810, where the gratis license is a single use license for an asset that expires in ten years and must be used within a two year period. As shown in FIG. 49, the partner can indicate creators or channels to provide the gratis license by providing channel identifiers or any other suitable identifier in creator identification section 4910. In a more particular example, as shown in FIG. 49, the storefront mechanisms can allow the partner to manage a gratis license by inputting user identifiers (e.g., “Creator A” through “Creator P”), input terms for the gratis license (e.g., expiration in 10 years, global territorial usage, use within 2 years, single use license, etc.), etc.

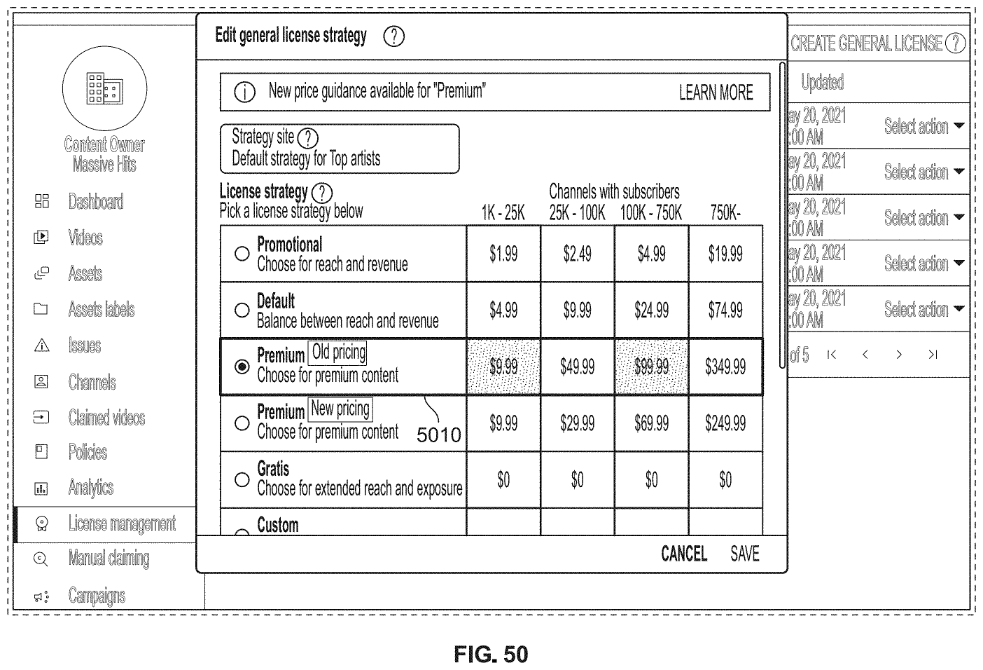

In some embodiments, the storefront mechanisms can allow a partner to modify a license strategy. For example, as shown in section 5010 of FIG. 50, the partner has modified a license strategy from a premium license strategy having an old pricing scheme based on the number of subscribers associated with a channel to a premium license strategy having a new pricing scheme based on the number of subscribers associated with a channel.

### License Usage

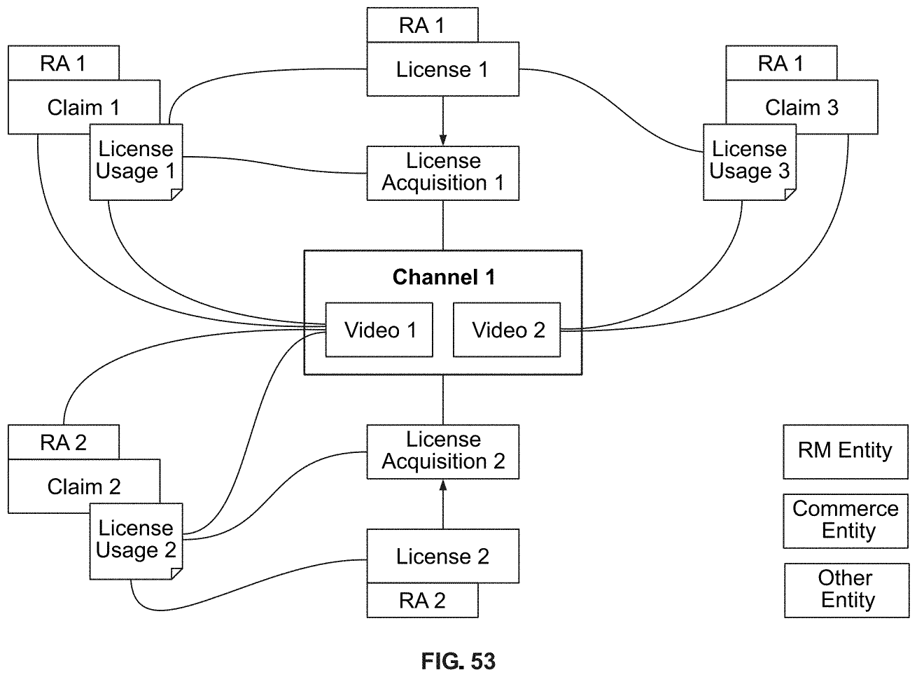

As described above, a creator can use an acquired license to an asset on a content item to declare their rights to use the asset, where the usage-related data is called a license usage. FIG. 53 shows an illustrative graph showing the relationship between license usage and related entities.

With regard to asset versus license usage, it should be noted that one asset can have multiple license usages associated with the asset, while one license usage is associated with one asset. For example, as shown in FIG. 53, reconciled asset 1 (RA1) has multiple license usages (License usage 1 and License usage 2), but each license usage is associated with one asset (e.g., License usage 1 with RA1).

With regard to license versus license usage, it should be noted that one license may have multiple license usages, while one license usage comes from only one license. For example, as shown in FIG. 53, License 1 has multiple license usages (e.g., License usage 1 and License usage 3).

With regard to license acquisition versus license usage, it should be noted that one license acquisition can have multiple license usages, while one license usage comes from only one license acquisition. For example, as shown in FIG. 53, License acquisition 1 has multiple license usages (e.g., License usage 1 and License usage 3). In some embodiments, a license can be configured to have a fixed number of license usages.

With regard to content item versus license usage, it should be noted that one content item can be applied with multiple license usages (e.g., due to multiple assets within the content item), while one license usage can only be applied to one content item. For example, as shown in FIG. 53, Video 1 has multiple license usages (e.g., License usage 1 and License usage 2).

With regard to claim versus license usage, it should be noted that one third party claim can have multiple license usages, while one license usage can only be associated with one third party claim. For example, one third party claim can have multiple license usages over time, but one active at the same time. In another example, one third party claim may have multiple license usages for different territories at the same time.

As also described above, usage-related data for a license usage can include a license identifier (which license is this license usage from), a content identifier (which content item is this license used on), a claim identifier (which third party claim is this license associated with), a license entitlement identifier (which license acquisition is this license usage from), a channel identifier (which channel associated with the creator initiated this license usage), a reconciled asset identifier (which asset is this license usage based on), and additional time-related fields, such as usage start time, usage expiration time, etc.

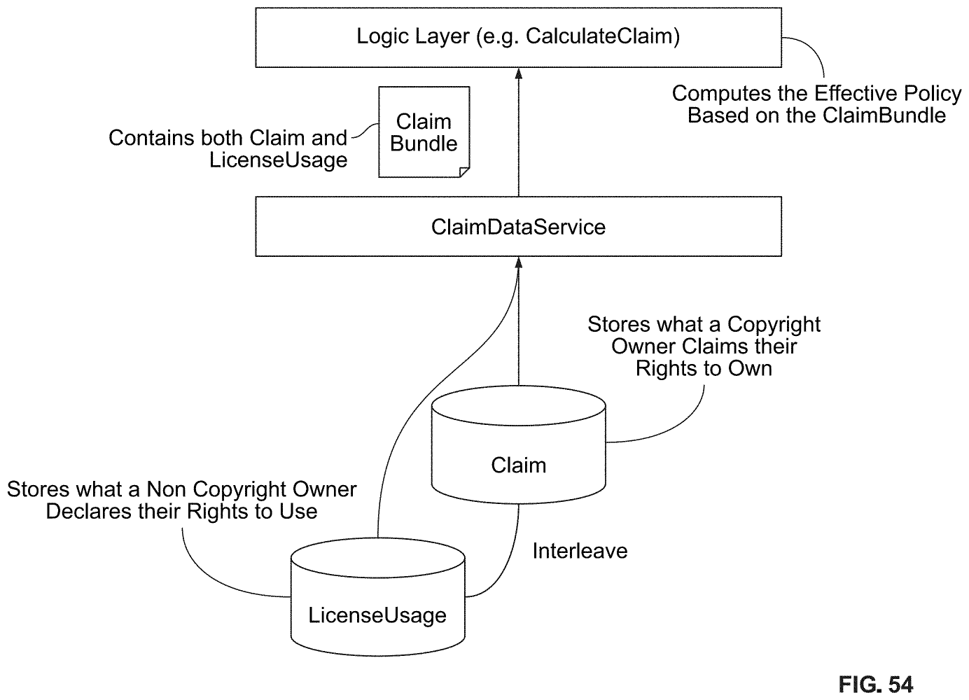

In some embodiments, for the license usage data model, a new entity can be created that has its own table (e.g., LicenseUsage), which stores information about what a creator declares their rights to use an asset on a content item. This LicenseUsage table can be a child table from a Claim table, where (VideoId, ClaimId, LicenseId) can be its primary key. When a LicenseUsage is active (e.g., denoted by a flag), the associated claim's policy can be affected. For example, as shown in FIG. 54, in response to using a license in an upload flow (e.g., when uploading a content item containing an asset owned by a third party), an active claim can be created and an active LicenseUsage can be created as a child entity of the claim. To protect content items with license usages, existing claims on the content item are loaded, which contain the LicenseUsage, and such information can be used to determine if the relevant segment should be protected. The mechanisms can compute effective claim policy and ownership using a logic layer based on the ClaimBundle that contains both the Claim and the LicenseUsage. It should be noted that, when a LicenseUsage is active, it acts as a mask on the third party claim's policy and ownership. The effective claim should return no policy. It should also be noted that, in some embodiments, territories can be stored in the LicenseUsage table, where territories can be taken into account by the logic layer when computing the effective policy and ownership on the content item.

This implementation can, for example, separate the storage of ownership information and right to use information. For example, Claim and LicenseUsage can each have their own status information. In another example, the usage-related data in the LicenseUsage table can be queried without querying the Claims table or obtaining all of the claim-related data.

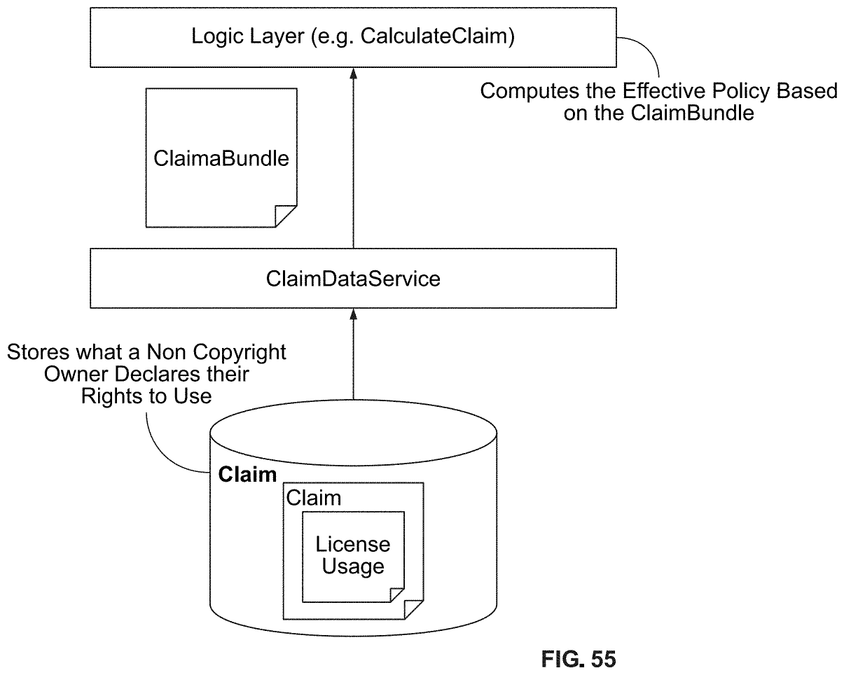

Alternatively, in some embodiments, the LicenseUsage table can be stored as additional data (e.g., new fields) in the Claim table. For example, license usage status can be represented by a new field, license_usage.status. A flag can be added to the claim to indicate that an active LicenseUsage is associated with it. This is shown, for example, in FIG. 55. In this implementation, when the claim is loaded in the logic layer, the logic layer contains both the third party claim information and the license usage information to perform the claim computation.

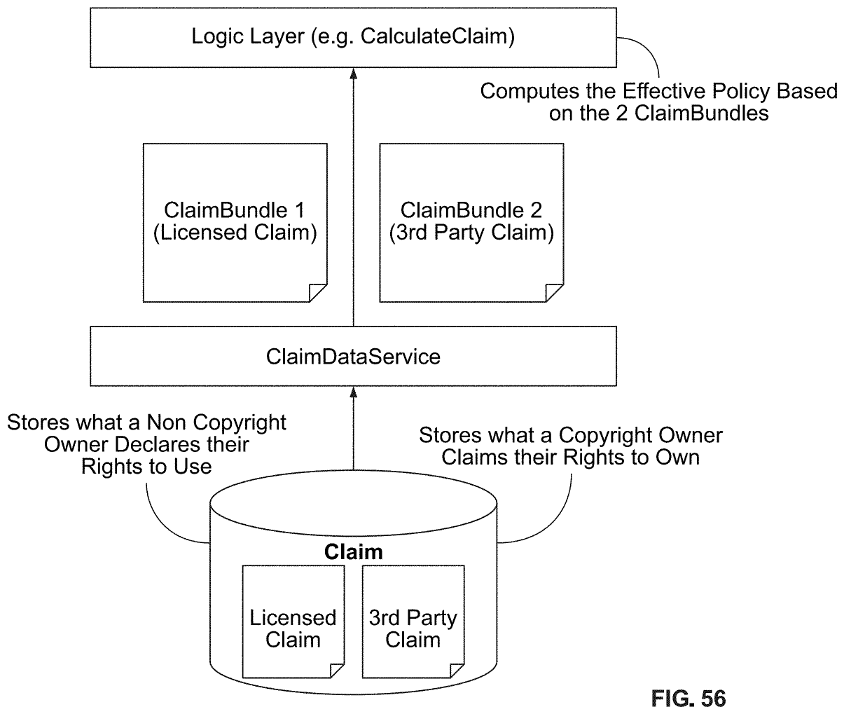

Alternatively, in some embodiments, a license usage can be defined as a type of claim, where (ClaimId, VideoId) can be its primary key. A licensed claim information about what a creator declares their rights to use an asset on a content item. The claim status represents the status of the license usage. When it is an active licensed claim, the active licensed claim can affect the effective policy of the third party claim with the same asset. For example, as shown in FIG. 56, an active match/manual claim can be created and a licensed claim can be created. To protect content items with license usages, existing claims on the content item are loaded including the third party claim and the licensed claim, and such information can be used to determine if the relevant segment should be protected. The mechanisms can compute effective claim policy and ownership using a logic layer based on the ClaimBundle(s) (e.g., the two ClaimBundles shown in FIG. 56).

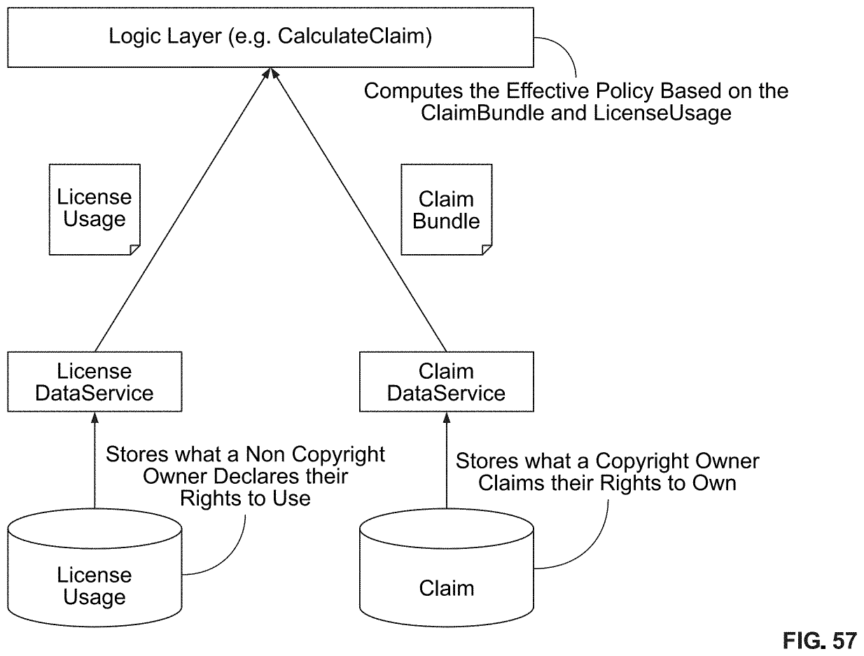

Alternatively, in some embodiments, the LicenseUsage table can be stored as its own independent table, where (VideoId, LicenseId, AssetId) can be its primary key. This is shown, for example, in FIG. 57.

### Match Claiming

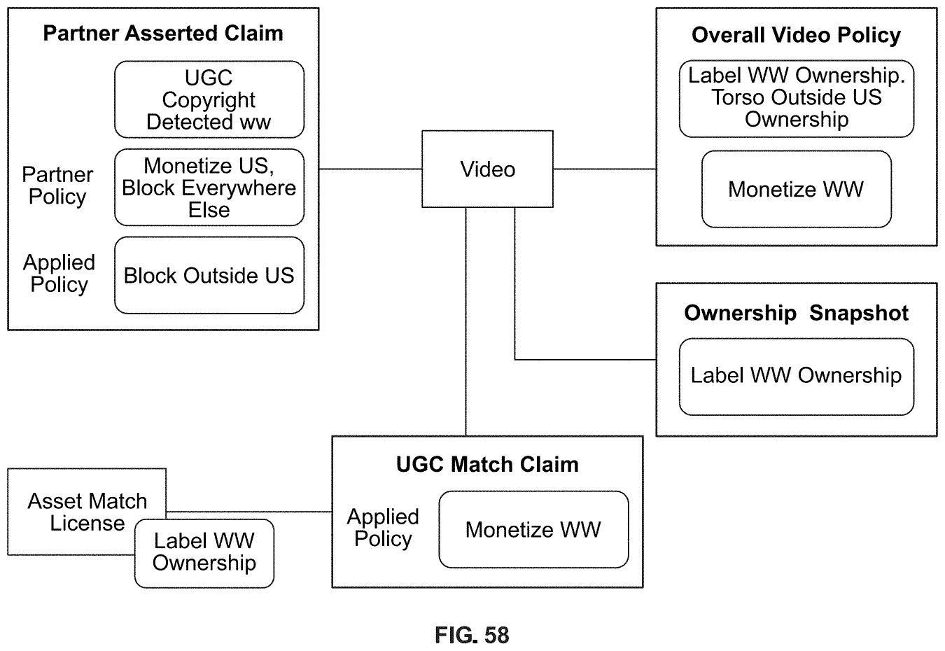

In prior implementations, when a partner has a third party claim, the content sharing service can close the first party claim and the creator can lose all control to set blocks on the content item and monetize. In some embodiments of the disclosed subject matter, rather than replacing the first party claim, the mechanisms described herein can annotate the claim with the information that the content item has a third party claim (e.g., if the partner in the first party claim does not quality for n-way revenue sharing). As shown in FIG. 58, the ownership snapshot calculation can be modified to only pull owners from claims in territories where the owner has a specified policy to track or monetize the asset.

In some embodiments, direct licenses can be modeled as a separate claim on the video (e.g., a Licensed Claim). For this class of licensed claims, licensed claims can prevent or replace match and manual user-generated content claims on the licensed segments, another claim cannot affect the state of a licensed claim even through it can affect the overall state of the video or content item, match claims can only replace other match claims, first party claims cannot be replaced by another claim, and license claims can be allowed to be created without an explicit policy.

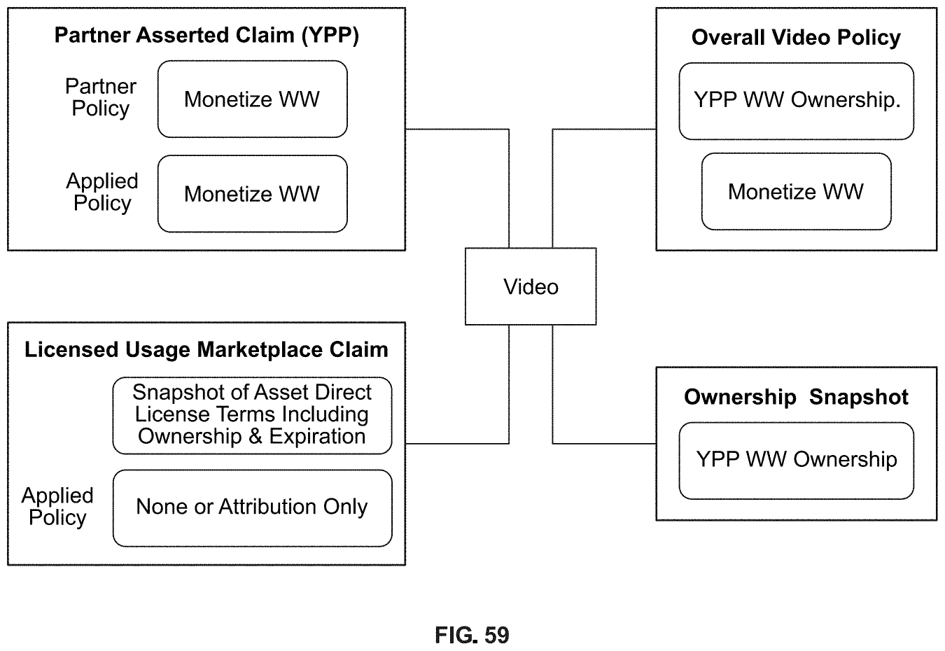

In the instance of a direct license acquired from the marketplace and a licensed claim is created, the terms of the direct license in the marketplace can be attached to the claim as a particular license usage so that the asset ownership/asset match policies do not pertain. For example, as shown in FIG. 59, the creator has selected to create a first party claim on their video and, since there is no copyright issue detected, their ownership and policy flood downstream.

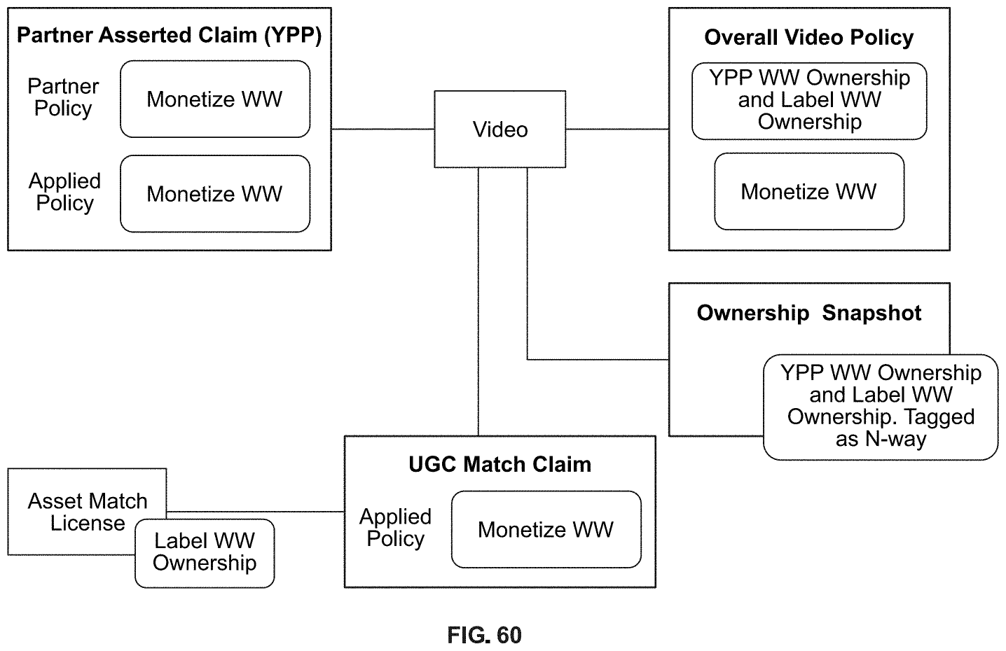

In the instance in which a particular license usage from the marketplace is revoked by an issuer (or expires), a flexible revenue distribution can be provided (sometimes referred to as “n-way”). For example, as shown in FIG. 60, if the license usage is revoked by the issuer, the claim becomes a UGC match claim and reverts to an asset match license.

Alternatively, in some embodiments, licensed claims can be modeled as additional data on a claim that describes how it is licensed rather than modeling licensed claims as claims. For example, claims can include three broad components: what is claimed (asset id, A/V channels, match/manual/synchronization segments), whether it is correctly claimed (origin, dispute/review state), how this claim should affect the video. As the component defining how this claim should affect the video is controlled by the rights type of the claim, whether claim-level administrative rights are present on the claim, the asset type of the asset claimed by the claim, and whether the claim has shorts synchronization origin, the mechanisms can extend this by replacing it with a claim field or message that can express at least the cases of indirect UGC licensing through the content sharing service, audioswap licensing, art track licensing, DMCA takedown licensing, shorts synchronization licensing, and direct licensing via one or more acquired licenses (e.g., acquired through the storefront).

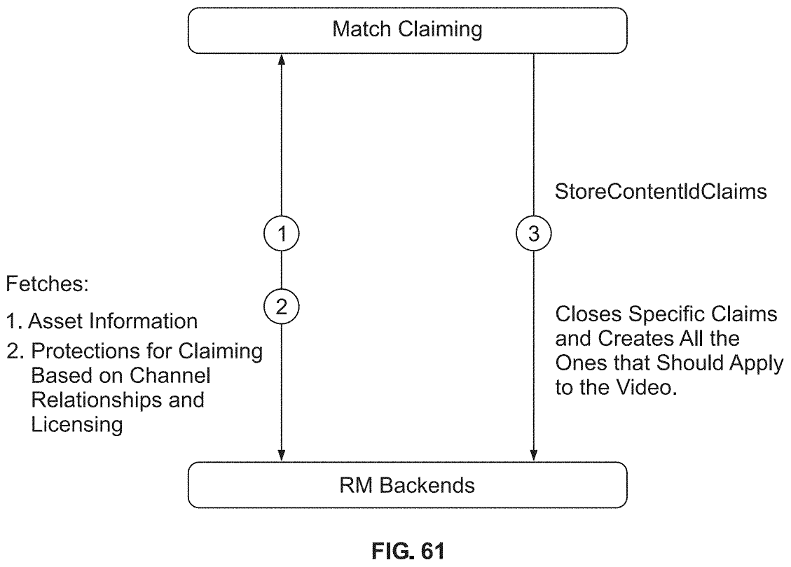

It should be noted that match claiming can integrate with the rights management mechanisms by fetching assets with a MatchedAssets API to determine if a claim should be made by returning asset ownership and match policy information. It should also be noted that match claiming can integrate with the rights management mechanisms by obtaining current claiming restriction rules using GetClaimingRestrictions to be applied in a match claiming logic layer. It should further be noted that match claiming can integrate with the rights management mechanisms by creating and/or replacing claims using StoreContentIdClaims. This is shown, for example, in FIG. 61, where match claiming mechanisms can fetch asset information and protections for claiming based on channel relationships and licensing from the rights management mechanisms and where match claiming mechanisms can close specific claims and create claims that should apply to the content item.

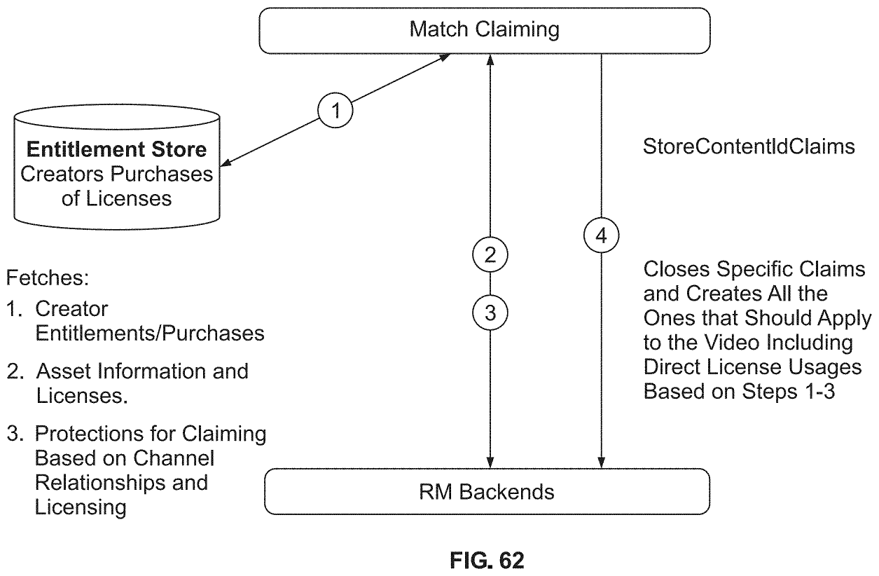

In some embodiments, the match claiming mechanisms can be configured to create all of the various claim types (e.g., UGC match claims and licensed claims). As shown in FIG. 62, the match claiming mechanisms can fetch (1) creator entitlements and purchases from an entitlement store, (2) asset information and licenses from the rights management mechanisms, and (3) protections for claiming based on channel relationships and licensing from the rights management mechanisms. In continuing this example, the match claiming mechanisms can close specific claims and/or create claims that should apply to the content item including the direct license usages based on the fetched information about entitlements, asset licenses, and claiming restrictions.

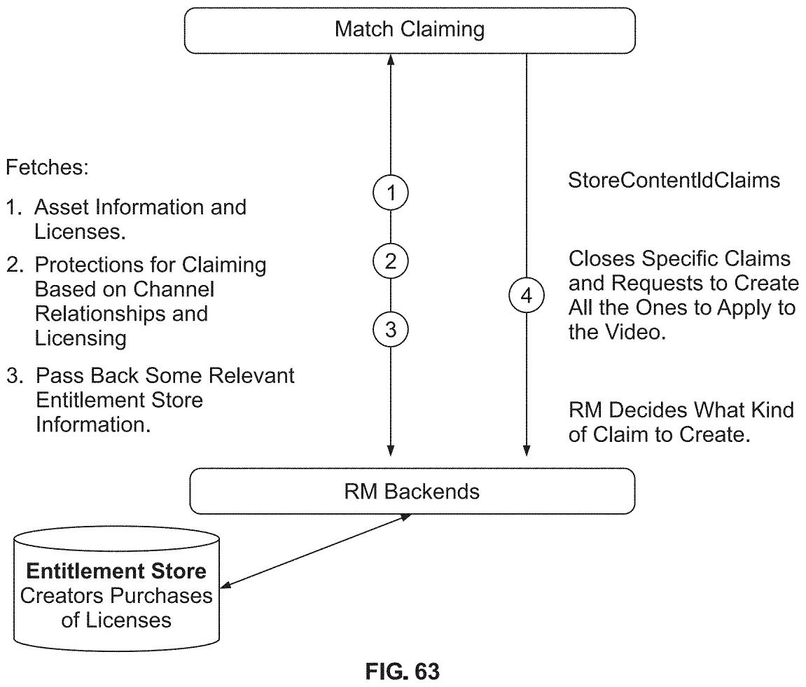

Alternatively, in some embodiments, the match claiming mechanisms can be configured to create match claims, where the rights management mechanisms can consolidate the license logic. For example, as shown in FIG. 63, the match claiming mechanisms can fetch asset information and licenses and protections for claiming based on channel relationships and licensing. It should be noted that entitlement information may need to be passed back to the match claiming mechanisms as the match claiming mechanisms may need the entitlement information in order to make decisions in connection with the creation of match claims. In continuing this example, the rights management mechanisms can take the request from the match claiming mechanisms to create a claim and use the knowledge of licensing and entitlements to make these claims the direct license claims, if applicable.

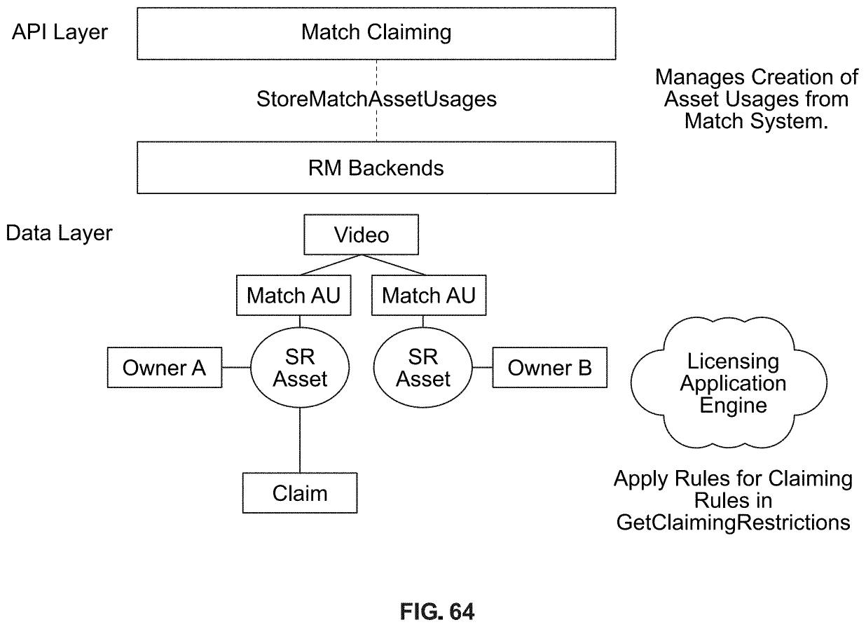

Alternatively, in some embodiments, the mechanisms can create a new layer of asset to video mapping entities from which claims can derive from. This can, for example, separate the construct of what a claim does to a content item into two parts: asset usage (linkage of video to an asset/reference) and claim (application of policy/embed/syndication rules on a video). As shown in FIG. 64, the match claiming mechanisms can create asset usages from the match system (e.g., without having to pull in logic about licensing). In continuing this example, match claiming can only be manipulating match asset usages freely and a separate layer of interpretation can determine which claims are materialized. The logic in the licensing application engine can apply rules for claiming in GetClaimingRestrictions.

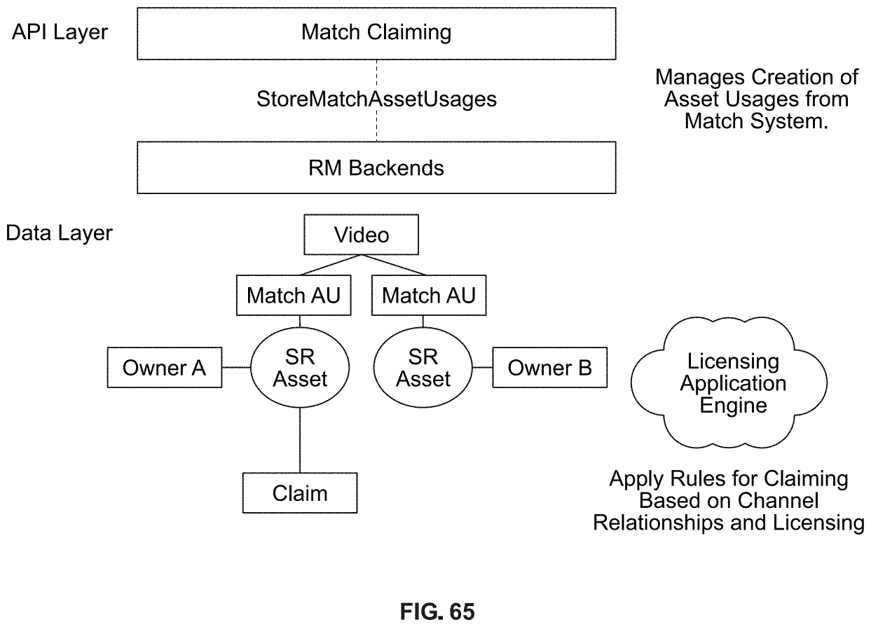

As shown in FIG. 65, in the instance in which a partner (Owner B) has declared this channel as being exempt from content detection (e.g., channel whitelisting), the logic in the licensing application engine can apply rules for claiming on the match asset usages based on channel relationships and licensing.

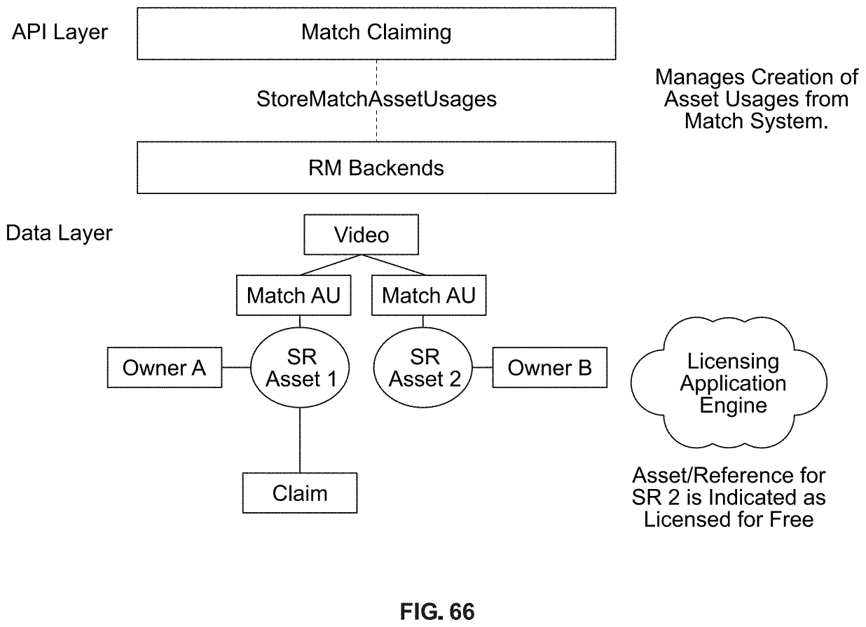

As shown in FIG. 66, in the instance in which an asset or reference (e.g., for SR Asset 2) is indicated as being licensed for free, the logic in the licensing application engine can apply rules for claiming on the match asset usages based on this indication.

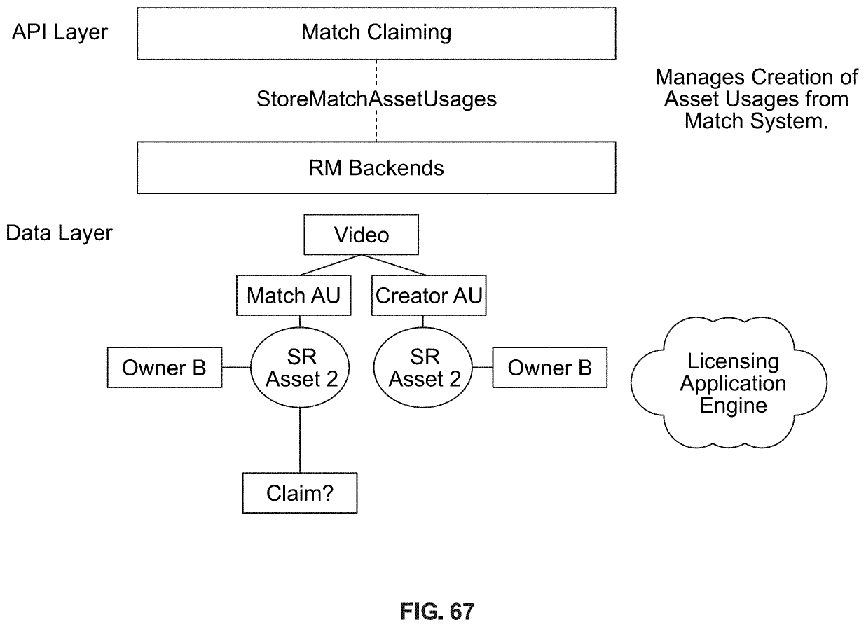

As shown in FIG. 67, in the instance in which a creator declares usage of a license upon uploading the content item that creates a creator-asserted asset usage, the logic in the licensing application can apply rules that would ratify the Creator AU in the data layer to prevent any match claims from being created and instead create a claim based on the details of the direct license.

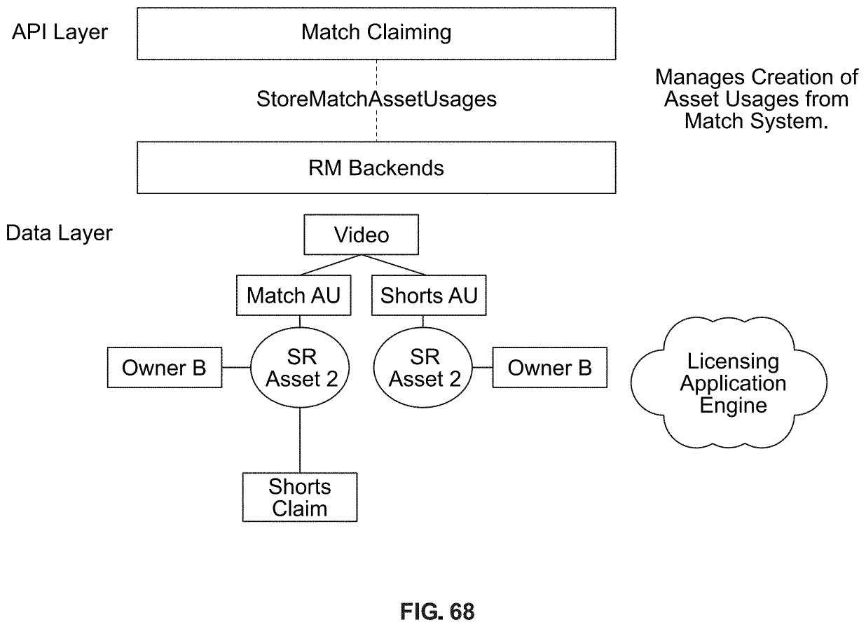

As shown in FIG. 68, in the instance of short form content items, an asset usage can be created that marks wherein the video the asset (e.g., music) for the short form content item was inserted. This can, for example, be performed when the short form content item is being uploaded to the content sharing service. The match claiming mechanisms can run independently and can create overlapping match asset usages. This, however, only results in the shorts claim shown in FIG. 68 upon the logic in the licensing application engine applying rules for claiming on the match asset usages. As also shown in FIG. 68, a match claim has not been created. In some embodiments, the licensing application engine can perform a check that the asset (e.g., SR Asset 2) is syncable for the short form content item.

### Overall System

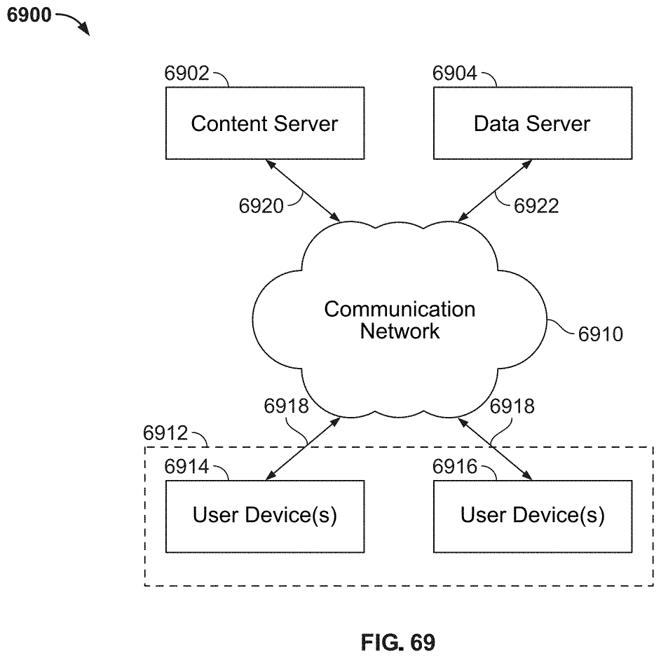

Turning to FIG. 69, an example 6900 of hardware that can be used in accordance with some embodiments of the disclosed subject matter is shown. As illustrated, hardware 6900 can include one or more servers, such as a content server 6902 and a data server 6904, as well as a communication network 6910, and/or one or more user devices 6912, such as user devices 6914 and 6916.

In some embodiments, content server 6902 can be any suitable server for storing media content and delivering the content to a user device 6912. For example, content server 6902 can be a server that streams media content to a user device 6912 via communication network 210. Media content provided by content server 6902 can be any suitable content, such as video content, audio content, electronic books, documents, images, and/or any other suitable type of media content. As a more particular example, media content can include television programs, movies, cartoons, sound effects, streaming live content (e.g., a streaming radio show, a live concert, and/or any other suitable type of streaming live content), and/or any other suitable type of media content. Media content can be created and uploaded to content server 6902 by any suitable entity. In some embodiments, content server 6902 can be omitted.

In some embodiments, data server 6904 can be any suitable server for storing and/or transmitting information related to one or more media content items. As a more particular example, in some embodiments, data server 6904 can store and/or transmit metadata that is associated with a media content item. As another more particular example, in some embodiments, data server 6904 can include a license table that, among other things, stores information related to licenses associated with assets and license usage information associated with applications of licenses to content items. In some embodiments, data server 6904 can be omitted.

Communication network 6910 can be any suitable combination of one or more wired and/or wireless networks in some embodiments. For example, communication network 6910 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 6912 can be connected by one or more communications links 6918 to communication network 6910 which can be linked via one or more communications links (e.g., communications links 6920 and/or 6922) to content server 6902 and data server 6904. Communications links 6918, 6920, and/or 6922 can be any communications links suitable for communicating data among user devices 6912 and servers 6902 and/or 6904 such as network links, dial-up links, wireless links, hard-wired links, any other suitable communications links, or any suitable combination of such links.

User devices 6912 can include any one or more user devices suitable for requesting media content, searching for media content, presenting media content, presenting advertisements, receiving input for playing media content and/or any other suitable functions. For example, in some embodiments, a user device 6912 can be implemented as a mobile device, such as a mobile phone, a tablet computer, a laptop computer, a vehicle (e.g., a car, a boat, an airplane, or any other suitable vehicle) entertainment system, a portable media player, and/or any other suitable mobile device. As another example, in some embodiments, a user device 6912 can be implemented as a non-mobile device such as a desktop computer, a set-top box, a television, a streaming media player, a game console, and/or any other suitable non-mobile device.

Although content server 6902 and data server 6904 are illustrated as separate devices, the functions performed by content server 6902 and data server 6904 can be performed using any suitable number of devices in some embodiments. For example, in some embodiments, the functions performed by either content server 6902 or data server 6904 can be performed on a single server. As another example, in some embodiments, multiple devices can be used to implement the functions performed by content server 6902 and data server 6904.

Although two user devices 6914 and 6916 are shown in FIG. 69 to avoid over-complicating the figure, any suitable number of user devices, and/or any suitable types of user devices, can be used in some embodiments.

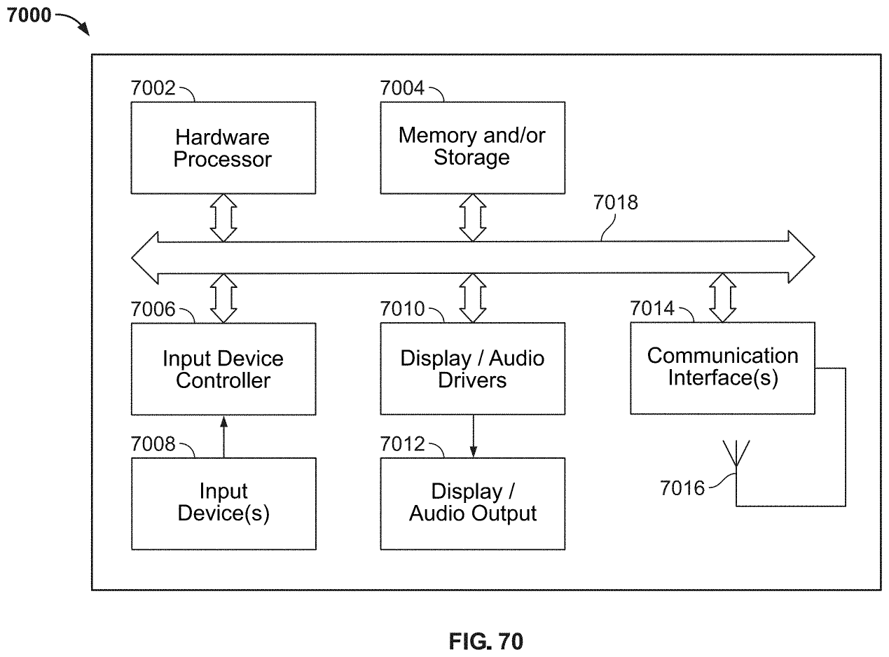

Content server 6902, data server 6904, and user devices 6912 can be implemented using any suitable hardware in some embodiments. For example, in some embodiments, devices 6902, 6904, and 6912 can be implemented using any suitable general purpose computer or special purpose computer. As another example, a mobile phone may be implemented using a special purpose computer. Any such general purpose computer or special purpose computer can include any suitable hardware. For example, turning to FIG. 70, as illustrated in example hardware 7000, such hardware can include hardware processor 7002, memory and/or storage 7004, an input device controller 7006, an input device 7008, display/audio drivers 7010, display/audio output circuitry 7012, communication interface(s) 7014, an antenna 7016, and a bus 7018.

Hardware processor 7002 can include any suitable hardware processor, such as a microprocessor, a micro-controller, digital signal processor(s), dedicated logic, and/or any other suitable circuitry for controlling the functioning of a general purpose computer or a special purpose computer in some embodiments. In some embodiments, hardware processor 7002 can be controlled by a server program stored in memory and/or storage 7004 of a server (e.g., such as one of servers 6902 or 6904). For example, the server program can cause hardware processor 7002 to perform the mechanisms described herein for language determination of a media content item based on comments and/or perform any other suitable actions. In some embodiments, hardware processor 7002 can be controlled by a computer program stored in memory and/or storage 7004 of a user device 7012. For example, the computer program can cause hardware processor 7002 to present a media content item, request a media content item, and/or perform the mechanisms described herein for language determination of a media content item based on comments.

Memory and/or storage 7004 can be any suitable memory and/or storage for storing application information, programs, data, media content, and/or any other suitable information in some embodiments. For example, memory and/or storage 304 can include random access memory, read-only memory, flash memory, hard disk storage, optical media, and/or any other suitable memory.

Input device controller 7006 can be any suitable circuitry for controlling and receiving input from one or more input devices 7008 in some embodiments. For example, input device controller 7006 can be circuitry for receiving input from a touchscreen, from a keyboard, from a mouse, from one or more buttons, from a voice recognition circuit, from a microphone, from a camera, from an optical sensor, from an accelerometer, from a temperature sensor, from a near field sensor, and/or from any other type of input device.

Display/audio drivers 7010 can be any suitable circuitry for controlling and driving output to one or more display/audio output devices 7012 in some embodiments. For example, display/audio drivers 7010 can be circuitry for driving a touchscreen, a flat-panel display, a cathode ray tube display, a projector, a speaker or speakers, and/or any other suitable display and/or presentation devices.

Communication interface(s) 7014 can be any suitable circuitry for interfacing with one or more communication networks, such as network 6910 as shown in FIG. 69. For example, interface(s) 7014 can include network interface card circuitry, wireless communication circuitry, and/or any other suitable type of communication network circuitry.

Antenna 7016 can be any of one or more suitable antennas for wirelessly communicating with a communication network (e.g., communication network 6910) in some embodiments. In some embodiments, antenna 7016 can be omitted.

Bus 7018 can be any suitable mechanism for communicating between two or more components 7002, 7004, 7006, 7010, and 7014 in some embodiments.

Any other suitable components can be included in hardware 7000 in accordance with some embodiments.

In some embodiments, at least some of the above described blocks of the processes in the figures can be executed or performed in any order or sequence not limited to the order and sequence shown in and described in connection with the figures. Also, some of the above blocks of the figures can be executed or performed substantially simultaneously where appropriate or in parallel to reduce latency and processing times. Additionally or alternatively, some of the above described blocks of the processes of the figures can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), and/or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, scaled content licensing platform and marketplace systems, methods, and media are provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for providing scaled content licensing, the method comprising:
receiving, using a hardware processor, a request from a content creator to upload a media content item to a content sharing service;
determining, using the hardware processor, that the media content item incorporates a media asset that is owned at least partially by a partner, wherein the media asset is associated with a claim in which at least one license is available;
determining, using the hardware processor, whether a license usage is associated with the media content item that corresponds with the media asset;
generating, using the hardware processor, a claim bundle that contains the claim associated with the partner and the license usage associated with the content creator;
determining, using the hardware processor, a policy based on the generated claim bundle; and
performing, using the hardware processor, an action on the media content item based on the determined policy.

2. The method of claim 1, wherein the license usage is stored in a child table of a claim table that stores a plurality of claims that are each associated with one or more licenses.

3. The method of claim 1, wherein the license usage is stored as a field of a claim table that stores a plurality of claims that are each associated with one or more licenses.

4. The method of claim 1, wherein the license usage is stored as a claim type of a claim table that stores a plurality of claims that are each associated with one or more licenses.

5. The method of claim 1, wherein the license usage is stored in a license usage database that is separate from a claim database that stores a plurality of claims that are each associated with one or more licenses.

6. The method of claim 1, further comprising detecting whether the media content item includes one or more media assets in response to receiving the request to upload the media content item to the content sharing service, wherein the claim is generated in response to detecting the media asset in the media content item in which the media asset is owned at least partially by the partner.

7. The method of claim 1, further comprising determining that the at least one license can be acquired from the partner, wherein the at least one license is associated with license terms.

8. The method of claim 7, further comprising causing license options to be presented to the content creator in response to determining that the at least one license can be acquired from the partner.

9. The method of claim 7, wherein the license terms include an option to purchase the at least one license based on revenue generated from the media content item.

10. The method of claim 7, wherein the license terms include an option to purchase the at least one license using an electronic payment system associated with a user account of the content creator.

11. The method of claim 1, wherein the action performed on the media content item based on the determined policy includes determining whether to inhibit the media content item from being provided to other users of the content sharing service based on the determined policy.

12. The method of claim 1, wherein the action performed on the media content item based on the determined policy includes determining whether the media content item is eligible for monetization based on the determined policy.

13. The method of claim 1, further comprising generating one or more recommendations for replacing the media asset included in the media content item in response to determining that the at least one license is unavailable for acquisition from the partner corresponding to the media asset.

14. The method of claim 1, further comprising
receiving a selection of a purchased license that is associated with the media asset; and
activating the purchased license in which the purchase license is applied to the media content item.

15. The method of claim 1, further comprising determining a license strategy is associated with the media asset.

16. The method of claim 15, wherein the license strategy indicates a gratis license associated with the media asset.

17. The method of claim 16, wherein the gratis license is associated with a usage expiration term, a territorial usage term, a time usage term, and a license usage term and wherein the gratis license is specified by the partner to one or more content creators using a user identifier.

18. The method of claim 1, further comprising transmitting the media asset to the content creator for temporary insertion into the media content item.

19. A scaled content licensing system, the system comprising:
a server that includes a hardware processor, wherein the hardware processor is configured to:
receive a request from a content creator to upload a media content item to a content sharing service;
determine that the media content item incorporates a media asset that is owned at least partially by a partner, wherein the media asset is associated with a claim in which at least one license is available;
determine whether a license usage is associated with the media content item that corresponds with the media asset;
generate a claim bundle that contains the claim associated with the partner and the license usage associated with the content creator;
determine a policy based on the generated claim bundle; and
perform an action on the media content item based on the determined policy.

20. A non-transitory computer-readable medium containing computer-executable instructions that, when executed by a processor, cause the processor to perform a method for providing scaled content licensing, the method comprising:
receiving a request from a content creator to upload a media content item to a content sharing service;
determining that the media content item incorporates a media asset that is owned at least partially by a partner, wherein the media asset is associated with a claim in which at least one license is available;
determining whether a license usage is associated with the media content item that corresponds with the media asset;
generating a claim bundle that contains the claim associated with the partner and the license usage associated with the content creator;
determining a policy based on the generated claim bundle; and
performing an action on the media content item based on the determined policy.
